(19) United States
(12) Patent Application Publication
(10) Pub. No.: US 2022/0147884 A1
(43) Pub. Date: May 12, 2022

(54) Systems and Methods for Nonconforming Service Facilitation for Multi-Modal Services

(71) Applicant: Uber Technologies, Inc., San Francisco, CA (US)

(72) Inventors: Christopher Hill Courtney, Half Moon Bay, CA (US); Adam Warmoth, San Francisco, CA (US)

(21) Appl. No.: 17/516,996

(22) Filed: Nov. 2, 2021

Related U.S. Application Data
(60) Provisional application No. 63/111,816, filed on Nov. 10, 2020.

(51) Int. Cl. G06Q 10/02; G06Q 50/30

(52) U.S. Cl. CPC G06Q 10/02; G06Q 50/30

(57) ABSTRACT

Systems and methods for facilitating non-conforming services are provided. A service entity can collaborate with a number of vehicle providers to facilitate a multi-modal transportation service. The service entity can obtain demand information for real-time or predicted requests for multi-modal transportation services and schedules for facilitating portions of the multi-modal transportation services. The schedules can be scheduled by a number of different vehicle providers according to scheduling preferences. The service entity can leverage the demand information to determine a non-conforming service in addition to the schedules that does not conform to a scheduling preference of a vehicle provider and provide a request to the vehicle provider to schedule the non-conforming service. The request can include offsetting attributes like an anticipated demand for the non-conforming service or a service subsequent to the non-conforming service to offset computing resources expended by performing the non-conforming service.

### RELATED APPLICATIONS

This application claims priority to and the benefit of U.S. Provisional Patent Application No. 63/111,816, filed Nov. 10, 2020, which is hereby incorporated by reference in its entirety.

### FIELD

The present disclosure relates generally to vehicle services and, more particularly, facilitating multi-modal vehicle services.

### BACKGROUND

A wide variety of modes of transport are available within cities. For example, people can walk, ride a bike, drive a car, take public transit, or use a ride sharing service. As population densities and demand for land increase, however, many cities are experiencing problems with traffic congestion and the associated pollution. Consequently, there is a need to expand the available modes of transport in ways that can reduce the amount of traffic without requiring the use of large amounts of land. Air travel, water travel, and underground travel within cities can reduce travel time over purely ground-based approaches and alleviate problems associated with traffic congestion. Multi-modal itineraries that combine a number of different transportation modalities provide opportunities to expand transport networks for cities and metropolitan areas. However, the transfer from one modality to another can present technical problems.

### SUMMARY

Aspects and advantages of embodiments of the present disclosure will be set forth in part in the following description, or can be learned from the description, or can be learned through practice of the embodiments.

An example aspect of the present disclosure is directed to a computing system. The computing system includes one or more processors and one or more tangible, non-transitory, computer readable media that collectively store instructions that when executed by the one or more processors cause the computing system to perform operations. The operations include obtaining multi-modal transportation service data indicative of a plurality of multi-modal transportation services. The plurality of multi-modal transportation services are associated with one or more transportation services. Each multi-modal transportation service includes at least two transportation legs. The operations include obtaining one or more transportation schedules for facilitating the one or more transportation services. The one or more transportation schedules are associated with one or more vehicle providers. Each of the one or more vehicle providers are associated with one or more scheduling preferences. The operations include determining a non-conforming service based, at least in part, on the one or more transportation services and the one or more transportation schedules. The non-conforming service violates at least one of the one or more scheduling preferences for at least one of the one or more vehicle providers. The operations include determining one or more offsetting attributes associated with the non-conforming service based, at least in part, on the multi-modal transportation service data. The operations include generating a request for the at least one vehicle provider. The request includes a request to schedule the non-conforming service and the one or more offsetting attributes. And, the operations include providing the request to the at least one vehicle provider.

Another example aspect of the present disclosure is directed to a computer-implemented method. The method includes obtaining, by a computing system comprising one or more computing devices, multi-modal transportation service data indicative of a real-time demand for one or more multi-modal transportation services. Each multi-modal transportation service includes at least two transportation legs. At least one of the at least two transportation legs are facilitated by at least one of the one or more transportation services. The method includes obtaining, by the computing system, one or more schedules for facilitating the one or more transportation services. The one or more schedules are associated with one or more vehicle providers. Each of the one or more vehicle providers are associated with one or more scheduling preferences. The method includes determining, by the computing system, a non-conforming service for facilitating the one or more transportation services. The non-conforming service violates at least one of the one or more scheduling preferences for at least one of the one or more vehicle providers. The method includes generating, by the computing system, a request for the at least one vehicle provider. The request includes a request to schedule the non-conforming service and one or more offsetting attributes. And, the method includes providing, by the computing system, the request to the at least one vehicle provider.

Yet another example aspect of the present disclosure is directed to another computing system. The computing system includes one or more processors and one or more tangible, non-transitory, computer readable media that store instructions that when executed by the one or more processors cause the computing system to perform operations. The operations can include obtaining multi-modal transportation service data indicative of a plurality of multi-modal transportation services. The plurality of multi-modal transportation services are associated with one or more transportation services. Each multi-modal transportation service includes at least two transportation legs. At least one of the at least two transportation legs are facilitated by at least one of the one or more transportation services. The operations include obtaining data from one or more vehicle providers. The data is indicative of a number of vehicles at one or more times for facilitating the one or more transportation services. The data is associated with one or more permissions corresponding to at least one of the one or more vehicle providers. The operations include generating one or more multi-modal transportation itineraries based, at least in part, on the multi-modal transportation service data and the data indicative of the number of vehicles at the one or more times for facilitating the one or more transportation services. The operations include determining a deviation associated with the data indicative of the number of vehicles at the one or more times for facilitating the one or more transportation services from the at least one vehicle provider. The deviation is indicative of a lower number of vehicles at one or more of the one or more times. The operations include generating one or more modified multi-modal transportation itineraries based, at least in part, on the deviation and the one or more multi-modal transportation itineraries. The operations include generating a deviation offset based, at least in part, on the one or more modified itineraries and the one or more permissions. And, the operations include providing the deviation offset to the at least one vehicle provider.

Other aspects of the present disclosure are directed to various systems, apparatuses, non-transitory computer-readable media, user interfaces, and electronic devices. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a graphical diagram of an example transportation node according to example embodiments of the present disclosure;

FIG. 3 depicts a graphical diagram of an example set of transportation plans between an example set of transportation nodes according to example embodiments of the present disclosure;

FIG. 4 depicts an example vehicle provider ecosystem according to example embodiments of the present disclosure;

FIG. 5 depicts a graphical diagram of an example multi-modal transportation service itinerary according to example embodiments of the present disclosure;

FIG. 6 depicts a network model configured to generate multi-modal transportation services data according to example embodiments of the present disclosure;

FIG. 7 depicts an activity diagram for offsetting a deviation to data indicative of the number of vehicles at the one or more times for facilitating one or more transportation services from the at least one vehicle provider according to example embodiments of the present disclosure;

FIG. 8 depicts a data flow diagram for generating a non-conforming service request according to example embodiments of the present disclosure;

FIG. 9 depicts a flow chart diagram of an example method for generating a non-conforming service according to example embodiments of the present disclosure; and

FIG. 10 depicts a block diagram of an example computing system according to example embodiments of the present disclosure.

### DETAILED DESCRIPTION

Aspects of the present disclosure are directed to improved systems and methods for multi-modal transportation services. In particular, aspects of the present disclosure are directed to utilizing prediction and real-time demand information to proactively determine, request, and allocate a vehicle provider for services that may not initially conform to the provider's scheduling preferences. In addition, the demand information can be utilized to offset inefficiencies incurred by a vehicle provider's failure to meet vehicle demands throughout an operational time period. For instance, a service entity can manage and coordinate a plurality of different types of vehicles to provide services to a plurality of riders via a transportation platform. A service entity computing system associated with the service entity (e.g., a cloud-based computing system, etc.) can obtain data indicative of a service request from one or more riders and generate one or more multi-modal transportation itineraries (e.g., rider itinerary, ground itinerary, flight itinerary, subterranean itinerary, nautical itinerary, etc.) to facilitate transporting the rider from the origin location to the destination location. The multi-modal transportation itinerary can include at least two types of transportation such as, for example, a ground-based vehicle transportation and an alternative transportation. The alternative transportation can include transportation using one or more transportation modalities alternative to the ground-based vehicle transportation. The one or more transportation modalities, for example, can include one or more aerial modalities associated with a plurality of aerial vehicles (e.g., jet planes, vertical take-off and landing vehicles, etc.); one or more aquatic modalities associated with one or more aquatic vehicles (e.g., ferries, cruise ships, speedboats, etc.); one or more subterranean modalities associated with one or more underground vehicles (e.g., subways, etc.); one or more ground-level modalities associated with one or more ground vehicles (e.g., scooters, bikes, etc.), etc. The multi-modal itinerary can include three legs: a first leg that includes a ground-based vehicle transporting a rider from the origin location (e.g., a home, etc.) to a first transportation facility; a second leg (e.g., an alternative portion) that includes an vehicle of an alternative modality transporting the rider from the first transportation facility to a second transportation facility; and a third leg that includes another ground-based vehicle transporting the rider from the second aerial transportation facility to the destination location (e.g., a conference center).

The present disclosure describes multi-modal transportation services including aerial transportation legs for exemplary purposes only. One of ordinary skill in the art would understand based on the present disclosure that the systems and methods disclosed herein would be equally applicable to multi-modal transportation services including transportation legs serviced by vehicles of any of a plurality of different transportation modalities such as, for example, any of the transportation modalities described herein.

With reference to multi-modal transportation services including aerial transportation, the service entity computing system can leverage one or more flight schedule(s) provided by a number of aerial vehicle providers to schedule an aerial portion of each multi-modal transportation itinerary. Each flight schedule can be created by a respective aerial vehicle provider in accordance with one or more scheduling preference(s) (e.g., preference to avoid deadheads, preference to utilize certain aerial transportation facilities, etc.) of the respective provider. The service entity computing system can obtain the flight schedule(s) and multi-modal transportation service data indicative of demand (e.g., real-time or predicted) for multi-modal transportation services. Based on the demand, the computing system can determine that an additional flight not conforming to the preferences of a respective aerial vehicle provider can facilitate transportation services that cannot be facilitated by the flight schedule(s). To incentivize the scheduling of the non-conforming service, the computing system can generate a flight request with one or more offsetting attributes (e.g., an anticipated capacity for a flight subsequent to a deadhead flight, an availability of energy-replenishment devices at a third-party facility, etc.). The vehicle request can be provided to the aerial vehicle provider and, if accepted, the computing system can perform one or more actions (e.g., booking passengers for a flight subsequent to the non-conforming service, reserving infrastructure devices at a third-party facility to service a vehicle before/after/during a non-conforming service, etc.) to provide the offsetting attributes. In some implementations, this operation can occur while the assigned aerial vehicle is inflight such that it can be deployed/assigned to a subsequent assignment, even before it lands. In this manner, the service entity computing system can effectively utilize demand data to anticipate a need for flights that initially do not conform to the preferences of an aerial vehicle provider and proactively generate contingencies for such flights through flight request customization and provision.

In some cases, the aerial vehicle provider(s) can provide access to one or more aerial vehicle(s) during one or more operational period(s) for use to perform aerial transportation services. For example, the aerial vehicle provider(s) can provide flight data indicative of a number of aerial vehicles for facilitating the aerial transportation service(s) and permission(s) (e.g., a compensation for deviating from the number of aerial vehicles, etc.) corresponding to the number of vehicles. The service entity computing system can generate a number of multi-modal transportation itineraries to facilitate the demand (e.g., predicted, or real-time) for transportation services based on the flight data. During the operational time period, the service entity computing system can determine a deviation from the number of aerial vehicles (e.g., less aerial vehicles have been provided than promised). In response, the service entity computing system can generate modified multi-modal transportation itineraries to compensate for the deviation and one or more deviation offset(s) to offset inefficiencies (e.g., larger fare for schedule changes, etc.) of the modified multi-modal transportation itineraries to the aerial vehicle provider. The deviation offset can be generated in accordance with the permissions granted by the aerial vehicle provider. In this manner, the service entity computing system can anticipate deviations to multi-modal transportation itineraries caused by an aerial vehicle provider and reduce the effect of the inefficiencies of mitigating such deviations.

The systems and methods of the present disclosure provide improved techniques for facilitating, planning, and optimizing a number of multi-modal transportation services throughout an operational time period. For instance, a system can anticipate a need for aerial transportation services (e.g., non-conforming to scheduling preferences of an aerial vehicle provider, due to deviations from a number of vehicles promised by an aerial vehicle provider, etc.) based on demand information for multi-modal transportation services. The system can generate one or more requests to schedule non-conforming services or modify multi-modal transportation itineraries to compensate for the anticipated transportation needs. In this way, the system and methods of the present disclosure provide improved computing techniques for collaborating with third-party computing systems to facilitate multi-modal transportation services. This can be done by generating new types of requests specifically tailored to incentivize flights not conforming to an aerial vehicle provider's preferences. This, in turn, enables the system to optimally schedule a plurality of multi-modal transportation itineraries with aerial transportation services that would not otherwise be available.

More particularly, a service entity can be associated with a service entity computing system (e.g., a cloud-based operations computing system, etc.) that is configured to manage, coordinate, simulate, and/or dynamically adjust a multi-modal transportation service via a transportation platform. The multi-modal transportation service can include a plurality of transportation legs, one of which (e.g., a second transportation leg) can include an aerial transportation of a rider. For example, the service entity computing system can obtain a request for a transportation service. The request for the transportation service can include at least a request for an aerial transport of a rider of the transportation platform. To facilitate the transportation service, the service entity computing system can create an end-to-end multi-modal itinerary that includes two or more transportation legs that include travel via two or more different transportation modalities such as, for example: cars, light electric vehicles (e.g., electric bicycles or scooters), buses, trains, aircraft, watercraft, and/or other transportation modalities. Example aircrafts can include helicopters and/or other vertical take-off and landing aircraft (VTOL) such as electric vertical take-off and landing aircraft (eVTOL).

The vehicles can include non-autonomous, semi-autonomous, and/or fully-autonomous vehicles provided and/or maintained by one or more vehicle provider(s). For instance, each vehicle can include a service entity vehicle provided and/or maintained by a service entity vehicle provider associated with the service entity computing system and/or a third-party vehicle provided and/or maintained by a third-party vehicle provider associated with a third party vehicle provider computing system. As described herein, the service entity computing system can provide cross-platform support to third-party vehicle providers. For instance, the service entity computing system can provide access to one or more services of the service entity to systems (e.g., third-party vehicle computing systems, third-party air traffic control systems, etc.) associated with third-party vehicle providers. As described herein, the service entity computing system can generate end-to-end itineraries for third party vehicles. In some implementations, this can be accomplished by utilizing information obtained via the third party vehicle provider (e.g., its associated computing system).

The service entity computing system can perform one or more algorithms to generate the end-to-end multi-modal itinerary for a rider. As an example, the service entity computing system can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first).

A transportation modality (e.g., a flight-based modality) can operate according to or within a fixed transportation infrastructure in which the ability of riders to embark and disembark vehicles is constrained to a defined set of transportation nodes. For example, the fixed transportation infrastructure can include a plurality of aerial vehicles (e.g., service entity aircraft, third-party aircraft, etc.) that operate within a ride sharing network facilitated by the service entity computing system. The aerial vehicle(s) can be constrained to load and unload riders only at a defined set of physical take-off and/or landing areas which may in some instances be referred to as aerial transportation facilities. Each aerial transportation facility can include one or more landing pads and/or other infrastructure to enable riders to safely embark or disembark from aerial vehicles. Aerial transportation facilities can also include charging equipment, cooling equipment, re-fueling equipment, and/or other infrastructure for enabling aircraft operation and/or maintenance. In some implementations, each aerial vehicle provider (e.g., service entity provider, third-party vehicle provider, etc.) can be affiliated with one or more of the defined set of physical take-off and/or landing areas. An affiliated aerial transportation facility, for example, can include infrastructure and/or space (e.g., parking areas, take-off/landing areas, etc.) provided, maintained, and/or owned by a respective affiliated aerial vehicle provider. An affiliated aerial vehicle provider can be configured to store (e.g., park, etc.), service, and/or otherwise facilitate an aerial transportation service from the one or more affiliated aerial transportation facilities.

The service entity computing system can include and/or be associated with a number of subsystems (e.g., world state system, forecasting system, optimization system, matching and fulfillment system, etc.) configured to provide a plurality of backend services to facilitate a transportation service. By way of example, an optimization/planning system can provide a backend itinerary service to generate one or more multi-modal transportation itineraries for a rider in accordance with the procedures described herein. In addition, the optimization/planning system can provide a backend routing service to determine one or more flight plans, routes, sky lanes, non-conforming services, etc. for vehicles associated with transportation service. Moreover, the service entity computing system can include a world state system, a forecasting system, and/or any other system capable of facilitating a transportation service. As one example, a world state system can operate a state monitoring system to maintain data descriptive of a current state of the world (e.g., a real-time transportation demand, flight assignments, operational statuses, and locations of a plurality of vehicles, etc.). For instance, the world state system can be configured to obtain world state data through communication (e.g., via an API platform) with one or more vehicles, aerial vehicle providers, and/or any other transportation entity associated with the service entity computing system. As another example, a forecasting system can operate a forecasting service to generate predictions of transportation demand, weather forecasts, and/or any other future looking data helpful for completing a transportation service.

The service entity computing system can interact with various vehicle providers (e.g., third-party vehicle providers, service entity vehicle providers, etc.). To do so, the service entity computing system can include an application programming interface platform to facilitate services between the service entity infrastructure (e.g., the services of the service entity computing system, service entity vehicle providers, etc.) and third-party vehicle providers (e.g., vehicle provider computing systems, etc.). The API platform can include one or more functional calls to the backend services of the service entity computing system. By way of example, the one or more functional calls can be configured to communicate a request and/or data between one or more subsystems (e.g., world state system, forecasting system, optimization/planning system, etc.) of the service entity computing system and one or more transportation entities associated with a transportation service (e.g., aerial vehicles, air traffic controllers, ground vehicles, pilots, passengers, etc.).

In some implementations, the service entity computing system may have at least some control over transportation services provided by service providers on at least some of the transportation modalities and, therefore, may pre-determine a number of planned transportation services by the service providers. For example, in some implementations, the operators of one or more aerial vehicles can be controlled by (e.g., contracted with) the service entity computing system. In such a case, the service entity computing system can generate (e.g., on a daily basis) an initial pre-defined set of flight plans for service entity aerial vehicles and can add or remove passengers from each planned flight. In addition, the service entity computing system can dynamically optimize planned transportation services by the service entity to account for real-time changes in rider availability and demand. For example, the service entity computing system can dynamically modify the pre-determined flight plans (e.g., delay a planned flight departure by five minutes and/or change a planned flight to an alternative arrival transportation node).

In addition, or alternatively, the service entity computing system can collaborate with one or more aerial vehicle provider computing system(s) to obtain one or more flight schedule(s) for facilitating the one or more aerial transportation services. For example, the flight schedule(s) can include at least one flight schedule associated with each aerial vehicle provider associated with the service entity. For example, each vehicle provider computing system can include a third-party computing system associated with a fleet of aerial vehicles capable of providing aerial transportation services for riders associated with the service entity computing system. Each vehicle provider computing system can include one or more communication interfaces communicatively connected to the service entity computing system such that the vehicle provider computing system can exchange information with the service entity computing system to schedule and/or provide one or more scheduled flight itineraries to the service entity computing system.

In some implementations, the vehicle provider(s) can provide flight data indicative of a number of aerial vehicles at one or more times for facilitating one or more aerial transportation services and the service entity computing system can generate flight schedules based on the flight data. In some implementations, the flight data can be associated with one or more permissions corresponding to at least one of the vehicle provider(s). The permission(s), for example, can include a compensation for a deviation to the flight data. By way of example, the permission(s) can be indicative of one or more covered inefficiencies for failing to achieve a number of aerial vehicles promised to the service provider at a respective time (e.g., at a time step, during a time range, etc.). For instance, the permission(s) can be included with the flight data to reduce wasted computing resources due to the service provider's failure to provide the number of aerial vehicles. In the event that the vehicle provider fails to achieve a number of promised vehicles, the permissions can enable the service entity computing system to offset inefficiencies (e.g., computing resources expended to mitigate the deviation, etc.) for mitigating transportation delays caused by the deviation from the number of vehicles.

In addition, or alternatively, the vehicle provider(s) can provide flight schedules indicative of a plurality of scheduled flight itineraries. For example, a vehicle provider computing system can be configured to manage, maintain, and schedule the fleet of aerial vehicles across a plurality of aerial transportation facilities based on information associated with the vehicles (e.g., vehicle data), multi-modal transportation services data (e.g., described in further detail herein), and/or vehicle provider preferences associated with the respective aerial vehicle provider. For example, each aerial vehicle provider of the vehicle provider(s) can be associated with one or more scheduling preference(s). The scheduling preference(s) can include a set of guidelines by which a vehicle provider computing system can schedule flight itineraries. The set of guidelines, for example, can be individually (and/or commonly) determined by a respective aerial vehicle provider (and/or a group of aerial vehicle providers, etc.) to maximize one or more desired flight outcomes such as, for example, one or more revenue goals, servicing goals, and/or passenger satisfaction goals of the respective aerial vehicle provider.

By way of example, the scheduling preference(s) can include at least one of a deadhead avoidance preference, a route preference, an aerial facility preference, a layover preference, and/or any other preference guiding the scheduling practices of an aerial vehicle provider. For example, the scheduling preference(s) can include a deadhead avoidance preference to maximize one or more revenue goals of the aerial vehicle provider. A deadhead flight, for example, can include a flight performed with little to no passengers for the purpose of moving an aerial vehicle from one aerial transportation facility to another. A revenue goal can include a minimum revenue generation for each scheduled flight. Thus, to maximize the revenue goal, a vehicle provider computing system can include a deadhead avoidance preference to minimize a number of deadhead flights scheduled throughout an operational period.

As another example, the scheduling preference(s) can include an aerial facility preference to maximize one or more revenue, servicing, and/or passenger satisfaction goals of the aerial vehicle provider. For instance, the aerial facility preference can include a plurality of aerial transportation facilities approved for operation by the aerial vehicle provider By way of example, the approved aerial transportation facilities can include one or more affiliated aerial transportation facilities that include infrastructure and/or space at least partly owned, leased, operated, and/or maintained by the aerial vehicle provider. The aerial facility preference can be indicative of one or more restricted (e.g., third-party, unaffiliated, etc.) aerial transportation facilities that are not affiliated with the aerial vehicle provider. By restricting the aerial transportation facilities to affiliated facilities, the aerial facility preference can be configured to maximize revenue (e.g., by minimizing the cost to maintain, store, etc. an aerial vehicle at a third-party facility), enhance servicing of an aerial vehicle (e.g., by using equipment owned/maintained by the aerial vehicle provider), and/or increase passenger satisfaction by using infrastructure affiliated with the aerial vehicle provider.

As yet another example, the scheduling preference(s) can include a route preference to maximize one or more revenue, servicing, or passenger satisfaction goals of the aerial vehicle provider. For instance, the routing preference can be indicative of a plurality of routes between affiliated aerial facilities. In addition, or alternatively, the routing preference can be indicative of one or more environment conditions, sky lanes, etc. that can be used to constrain scheduled routes for a scheduled flight. In addition, or alternatively, the scheduling preference(s) can include a layover preference to maximize one or more revenue, servicing, or pilot health goals. For example, the layover preference can be indicative of a time threshold for one or more layover(s) between scheduled flights. By way of example, the time thresholds can include a minimum time threshold (e.g., a minimum amount of time for servicing an aerial vehicle, etc.) and/or a maximum time threshold (e.g., a maximum amount of time before scheduling an additional flight). The maximum time threshold, for example, can be indicative of a restriction on overnight layovers, etc.

In some implementations, the service entity computing system can receive the vehicle provider preference(s) associated with each aerial vehicle provider from a respective vehicle provider computing system. In addition, or alternatively, the vehicle provider preference(s) can be inferred based on one or more flight schedules of a respective aerial vehicle provider. For example, each of the aerial vehicle provider(s) can be associated with historical data with the service entity. The aerial vehicle provider preferences associated with the one or more aerial vehicle provider(s) can be determined based, at least in part, on the historical data. As an example, the historical data can include a plurality of sets of flight schedules for one or more historical operational time periods. The aerial vehicle provider preference(s) can be determined based on one or more attributes shared by one or more of the sets of flight schedules. By way of example, a vehicle provider preference indicative of a deadhead avoidance preference can be inferred based on a repeated absence of deadhead flights, etc.

Each vehicle provider computing system can determine one or more flight schedule(s) in accordance with the respective preferences associated with the corresponding aerial vehicle provider. The flight schedule can include one or more flight itineraries for one or more available aerial vehicle(s) at one or more aerial transportation facilities during an operational time period. A flight itinerary, for example, can include one or more flight attributes. The one or more flight attributes can include a departure time, a departure location (e.g., the aerial transportation facility, a take-off location of the aerial transportation facility, etc.), a destination time (e.g., estimated time of arrival at a destination facility), a destination location, a vehicle capacity (e.g., number of passengers, etc.), a vehicle operator associated with the aerial transportation leg and/or any other information associated with the provision of an aerial transportation service.

The vehicle provider(s) can provide the flight schedules (and/or flight data) to the service entity computing system and the service entity computing system can generate one or more multi-modal transportation itineraries based, at least in part, on the flight schedules (and/or flight data) and multi-modal transportation service data. The service entity computing system can book and/or otherwise assign one or more riders to one or more of the flight itineraries (e.g., of the received flight schedule(s), or the scheduled flight itineraries based on flight data) based, at least in part, on the multi-modal transportation itinerary(s).

More particularly, the service entity computing system (e.g., an optimization/planning system) can receive multi-modal transportation services data indicative of one or more requests for a plurality of transportation services and generate the plurality of multi-modal transportation itineraries for facilitating the plurality of transportation services based on the one or more requests and the flight schedules provided by the vehicle provider(s) and/or scheduled based on the flight data received from the vehicle provider(s). For example, the multi-modal transportation service data can be indicative of a plurality of multi-modal transportation services. The plurality of multi-modal transportation services can be associated with one or more aerial transportation services. As an example, each multi-modal transportation service can include at least two transportation legs. At least one of the at least two transportation legs can be facilitated by at least one of the one or more aerial transportation services (e.g., via a flight itinerary of the one or more flight schedules or scheduled based on the flight data).

The multi-modal transportation service data can include one or more anticipated, real-time, and/or scheduled requests for a multi-modal transportation service. For example, the multi-modal transportation service data can include demand data including prediction data (e.g., anticipated requests) and/or current data (e.g., real-time/scheduled requests). As an example, the multi-modal transportation service data can include demand data indicative of a real-time demand (e.g., based on one or more real-time requests received at a current time) for one or more multi-modal transportation services, one or more scheduled multi-modal transportation services (e.g., based on one or more previously received requests received at a previous time), and/or any combination therebetween. In addition, or alternatively, the multi-modal transportation service data can include prediction data indicative of a plurality of anticipated aerial transportation services at one or more future times. The future times, for example, can include one or more time steps, periods, and/or ranges throughout an operational time period during which multi-modal transportation services are offered by the service entity.

By way of example, the multi-modal transportation services data can include demand data indicative of a plurality of anticipated requests and/or one or more aspects thereof. For instance, the demand data can be indicative of the one or more anticipated transportation services throughout the operational time period. By way of example, the service entity computing system (e.g., the forecasting system) can include a network model configured to predict the plurality of anticipated requests based on historical and/or real-time data. In some implementations, the network model can include one or more machine-learning models. The machine-learning models can include any machine-learning model (e.g., deep neural networks, convolutional neural networks, recurrent neural networks, recursive neural networks, decision trees, logistic regression models, support vector machines, etc.) and/or any other models configured to generate the demand data based on one or more inputs. In some implementations, the one or more machine-learning models can be learned (e.g., via one or more supervised training techniques) over a set of training data such as, for example, historical multi-modal transportation service data gathered over one or more previous operational time periods.

More particularly, the network model can include a demand model, a load modal, and/or an aerial transport usage model. The demand model can be configured to determine an anticipated demand for aerial transportation services at one or more times (e.g., time steps, ranges, periods, etc.) throughout the operational time period. The load model can be configured to estimate the maximum expected load factors at the one or more times (e.g., time steps, ranges, periods, etc.) throughout the operational time period. A load factor, for example, can identify a total expected weight to be transported. The aerial transport usage model can be configured to estimate an expected number of flights for each aerial transportation facility and/or aerial vehicle of the fixed transportation infrastructure at one or more times (e.g., steps, periods, ranges, etc.) throughout the operational time period. For example, the aerial transportation usage model can identify an expected number of aerial vehicles that will land, park, receive maintenance, and/or take off from each of a plurality of aerial transportation facilities.

In some implementations, the multi-modal transportation services data can include itinerary data indicative of a number of services expected to be requested during the operational time period and/or one or more expected transportation request attributes of each of the expected service requests. The one or more expected transportation request attributes, for example, can include a type of requested service (e.g., single passenger transportation, group passenger transportation, item transportation, etc.), a time sensitivity of the requested service, a capacity sensitivity of the requested service, one or more locations (e.g., origin, destination, etc.) associated with the requested service, etc. For example, the attribute(s) can identify an aerial transportation facility (e.g., an origin facility, an intermediate facility, a destination facility, etc.) associated with each expected request, a number of services expected to be fulfilled by each aerial transportation facility, a number/type aerial vehicles needed to service each of the expected requests, a number/type of aerial vehicles at each aerial transportation facility needed to service the expected requests, etc.

In some implementations, the service entity computing system can schedule one or more flight itineraries based on a number of vehicles identified by flight data provided by the aerial vehicle provider(s) and/or the multi-modal transportation service data. For instance, the service entity computing system can obtain the flight data from the aerial vehicle provider(s) and schedule one or more flight itineraries to facilitate one or more real-time and/or predicted transportation services identified by the multi-modal transportation services data. The service entity computing system can generate one or more multi-modal transportation itineraries based, at least in part, on the multi-modal transportation service data and the flight data (e.g., service entity scheduled itineraries). The service entity computing system can facilitate the provision of the multi-modal transportation itinerary(s) during an operational time period.

In some cases, (e.g., during the provision of the multi-modal transportation itinerary(s)) the service entity computing system can determine a deviation associated with the flight data from at least one aerial vehicle provider. A deviation, for example, can be indicative of a lower number of aerial vehicles at one or more time(s) during the operational time period than provided by the flight data. In the event of a deviation, the service entity computing system (e.g., a monitoring and mitigation system) can mitigate the aerial vehicle provider's failure to achieve the number of aerial vehicles identified by the flight data by generating one or more modified multi-modal transportation itineraries based, at least in part, on the deviation and/or the multi-modal transportation itinerary(s). The modified multi-modal transportation itinerary(s), for example, can include one or more different flight itineraries than the original multi-modal transportation itinerary(s).

By way of example, the service entity computing system can generate the modified multi-modal transportation itinerary(s) by determining one or more multi-modal transportation itinerary(s) affected by the deviation. The affected multi-modal transportation itinerary(s), for example, can include multi-modal transportation itinerary(s) with an aerial transportation leg associated with an unavailable aerial vehicle. The service entity computing system can obtain one or more additional flight itineraries and/or any other flight data indicative of one or more available aerial vehicles and, based on this data, modify the aerial transportation leg of the affected multi-modal transportation itinerary(s). This can include replacing the aerial transportation leg with an available aerial vehicle, a vehicle of another modality (e.g., book another ground transportation vehicle, extend the first transportation leg to cover the second transportation leg, etc.), etc.

The service entity computing system can generate a deviation offset based, at least in part, on the one or more modified itineraries and/or the one or more permissions associated with the flight data. The deviation offset, for example, can include an inefficiency associated with the one or more modified multi-modal transportation itineraries. By way of example, the deviation offset can include one or more inefficiencies associated with replacing (and/or modifying) the second transportation leg of the affected multi-modal transportation itinerary(s). The one or more inefficiencies, for example, can include an increased cost to schedule an available aerial vehicle (e.g., based on limited time, different inefficiencies associated with a different aerial vehicle provider, etc.), a cost to facilitate the availability of an aerial vehicle (e.g., servicing costs to increase the servicing (e.g., fueling, charging) speed of an aerial vehicle, downstream inefficiencies for using the aerial vehicle, overtime for an operator of the aerial vehicle, etc.), passenger inefficiencies for causing a transportation delay (e.g., a refund to a passenger issued by the service entity computing system to compensate for additional time caused by replacing an aerial transportation service with a ground transportation service, etc.), and/or any other inefficiencies associated with the modified multi-modal transportation itinerary(s).

The deviation offset can be based, at least in part, on the aerial vehicle provider and/or the permission(s) associated with the flight data. By way of example, each aerial vehicle provider can be associated with permission(s) enabling the service entity computing system to offset the inefficiencies of a deviation caused by the aerial vehicle provider. The permission(s) can include one or more permitted deviation offsets and/or one or more restricted deviation offsets. As an example, the permission(s) can include permitted deviation offset(s) allowing the recovery of the inefficiencies of scheduling an available aerial vehicle (e.g., by making infrastructure resources available to an aerial vehicle, etc.) and/or restricted deviation offsets restricting the recovery the inefficiencies associated with passenger compensation (e.g., by restricting refund offers, etc.). In such a case, the service entity computing system can generate deviation offsets based on the permitted deviations. The deviation offset can be provided to the aerial vehicle provider such that the aerial vehicle provider can account for deviations caused by the aerial vehicle provider.

In addition, or alternatively, the service entity computing system can optimize the scheduling of a plurality of multi-modal transportation itineraries based on the flight schedules provided by the aerial vehicle provider(s) (e.g., scheduled by the aerial vehicle providers in advance) and the real-time and/or anticipated transportation services (e.g., and/or one or more aspects thereof). For instance, the service entity computing system can attempt to generate a multi-modal transportation itinerary to maximize the number of real-time and/or anticipated services facilitated by the service entity computing system. At times, the flight schedule(s) provided by the aerial vehicle provider(s) (and/or one or more scheduling preferences of the aerial vehicle provider(s)) can be a limiting factor to the optimization of multi-modal transportation itineraries. In such a case, the service entity computing system can utilize the multi-modal transportation services data to generate a request for a flight (e.g., that facilitates one or more multi-modal transportation services) that is not included in the flight schedule(s).

For example, the service entity computing system can determine a non-conforming service (e.g., in addition to the scheduled flights) based, at least in part, on the one or more (e.g., real-time or predicted) aerial transportation services and/or the flight schedule(s) obtained from the vehicle provider(s). For instance, the service entity computing system can compare the multi-modal transportation services data to the flight schedule(s) (e.g., indicative of available flights) to determine whether an additional, unscheduled flight, may be beneficial for servicing the real-time and/or predicted demand. This can include, for example, a flight to compensate for an unavailable aerial vehicle due to an aerial vehicle provider's failure to provide a number of anticipated vehicles (e.g., as indicated by flight data). A non-conforming service can include a flight in addition to the flight itineraries of the flight schedule(s) that violates at least one of the one or more scheduling preference(s) for at least one of the aerial vehicle provider(s).

As an example, the service entity computing system can identify one or more aerial transportation services (e.g., anticipated, or real-time) that are not achieved by the flight schedule(s). The one or more aerial transportation services, for example, can include one or more anticipated and/or real-time aerial transportation services of a plurality of anticipated and/or real-time aerial transportation services identified by the multi-modal transportation services data. The service entity computing system can attempt to schedule a multi-modal transportation itinerary to facilitate each of the plurality of anticipated and/or real-time aerial transportation services identified by the multi-modal transportation services data. The one or more aerial transportation services can include services that cannot be facilitated based on the available flight itineraries of the provided flight schedule(s) (and/or the scheduled flights based on flight data).

As an example, the one or more real-time and/or anticipated aerial transportation services can be indicative of a greater demand (e.g., due to an event, environmental conditions, etc.) than expected at one or more of the aerial transportation facilities. As another example, the one or more real-time and/or anticipated aerial transportation services can be indicative of one or more movement trends detected by the service entity computing system. By way of example, the movement trend(s) can identify one or more expected return flights (e.g., for passengers that are engaged in an overnight trip, etc.), an increase in a number of flights between one or more aerial transportation facilities (e.g., due to a population increase, developments, congestion, etc. proximate to at least one of the aerial transportation facility(s), etc.), and/or any other trend identifying travel patterns.

The service entity computing system can determine the non-conforming service to facilitate the one or more real-time and/or anticipated aerial transportation services. The non-conforming service can be associated with at least one of one or more flight types depending on a scheduling preference violated by the flight. The flight type(s), for example, can include a deadhead flight, a restricted route flight, a restricted facility flight, a layover flight, and/or any other flight that violates a scheduling preference of a respective vehicle provider. For example, a deadhead flight can violate a deadhead avoidance preference, a restricted route flight can violate the route preference, a restricted facility flight can violate an aerial facility preference, a layover flight can violate a layover preference, etc. By way of example, a deadhead flight can include a deadhead flight (e.g., to move an aerial vehicle to a high demand aerial transportation facility) or cause a subsequent deadhead flight (e.g., to service an immediate demand with no subsequent demand). For example, the non-conforming service can include a route to an aerial transportation facility corresponding to a number of aerial transportation services. In this manner, the service entity computing system can determine the non-conforming service to position aerial vehicles at high demand aerial transportation facilities despite one or more non-conforming scheduling preferences.

As other examples, a restricted route flight can include a requested flight route that violates a route preference by causing an aerial vehicle to fly in undesirable environmental conditions (e.g., approved by the FAA standards, but restricted to increase passenger satisfaction, etc.) such as high turbulence, light rain, etc. In addition, or alternatively, the requested flight route can include one or more restricted (e.g., third-party, unaffiliated facilities) aerial transportation facilities as a waypoint. As another example, a restricted facility flight can request a flight that causes an aerial vehicle to fly to, park, and/or be serviced (e.g., charged, fueled, etc.) at an undesirable (e.g., third-party, unaffiliated, etc.) facility. For instance, an aerial facility preference can include one or more desirable facilities that are at least partially owned, operated, and/or otherwise affiliated with the aerial vehicle provider. A restricted facility flight can include a flight that lands and/or departs from an unaffiliated aerial transportation facility. A layover flight can include a flight that causes a layover under and/or over a preferred time threshold. Layover flights can include an overnight layover that violates a layover preference of a vehicle provider by exceeding a maximum time threshold. In addition, or alternatively, a layover flight can include a quick turnaround between two flights that fails to achieve a minimum time threshold. Such a flight can be determined, for example, to service a greater than expected demand at an aerial facility.

The service entity computing system can generate a flight request for the at least one of the aerial vehicle provider(s) based on the determined non-conforming service. For example, the flight request can include a request to schedule the non-conforming service. In addition, the flight request can include one or more offsetting attributes to offset a violation of scheduling preferences caused by the non-conforming service. By way of example, the flight request can include a request to schedule the non-conforming service, flight data indicative of one or more attributes (e.g., a flight route, a destination/departure location, a passenger capacity, etc.) of the non-conforming service, a preference violation associated with the non-conforming service (e.g., a passenger capacity of no passengers indicative of a deadhead flight), and/or the one or more offsetting attributes to offset the preference violation. The offsetting attributes, for instance, can include one or more guarantees (e.g., an increased payment, a capacity of a subsequent flight, etc.) to offset an expense associated with the preference violation.

For example, the service entity computing system can determine the offsetting attribute(s) based, at least in part, on the multi-modal transportation services data (e.g., real-time, anticipated transportation services, etc.) and the at least one scheduling preference violated by the non-conforming service. An offsetting attribute, for example, can include at least one of a compensation attribute, a subsequent trip attribute, and/or an infrastructure attribute. By way of example, a compensation attribute can be indicative of a compensation for facilitating the one or more aerial transportation services such as, for example, a rate guarantee (e.g., as opposed to per passenger compensation method, etc.) for performing the flight. The rate guarantee, for example, can be determined to cover one or more inefficiencies (e.g., fueling/charging costs, operator costs, vehicle inspection/servicing costs, etc.) of performing a non-conforming service. In addition, or alternatively, the rate guarantee can include a higher rate of compensation for the non-conforming service and/or one or more flights subsequent to the non-conforming service. For example, the higher rate of compensation can be determined in accordance with a demand (e.g., real-time and/or anticipated, etc.) at an aerial transportation facility. In some implementations, for example where the non-conforming service is requested in response to a deviation caused by a deviating vehicle provider, the compensation attribute can be indicative of a deviation offset provided by the deviating aerial vehicle provider.

In addition, or alternatively, the subsequent trip attribute can include a predicted and/or guaranteed capacity for a flight subsequent to the non-conforming service. As an example, the one or more offsetting attributes can be indicative of an anticipated capacity for a flight subsequent to the non-conforming service. For instance, the non-conforming service can include a deadhead flight to service demand from a destination aerial transportation facility. In such a case, the one or more offsetting attributes can include demand data indicative of an anticipated capacity for a flight subsequent to the non-conforming service (e.g., from the high demand aerial transportation facility, etc.). As another example, the non-conforming service can include a layover flight to service early demand from a destination aerial transportation facility. In such a case, the one or more offsetting attributes can include demand data indicative of an anticipated capacity for an early flight subsequent to (e.g., after a layover) the non-conforming service (e.g., from the high demand aerial transportation facility, etc.). In some implementations, as discussed herein, the service entity computing system can guarantee a capacity of a subsequent and/or early flight by booking one or more passengers for the subsequent/early flight subsequent to the non-conforming service before, during, and/or after the scheduling/performance of the non-conforming service.

The infrastructure attribute can include infrastructure data associated with the infrastructure of an aerial transportation facility. For example, in some implementations, an aerial transportation facility associated with a non-conforming service can include a third-party aerial facility that is unaffiliated with the at least one aerial vehicle provider (e.g., and thus violates a restricted facility scheduling preference of the aerial vehicle provider). In such a case, the one or more offsetting attributes can be indicative of the infrastructure at the third-party aerial transportation facility, an availability of the infrastructure, and/or an allowance to use the infrastructure. By way of example, the infrastructure attribute can include a guarantee to reserve and/or pay for third-party infrastructure at an unaffiliated aerial transportation facility. In some implementations, as discussed herein, the service entity computing system can guarantee the availability of the infrastructure at the unaffiliated aerial transportation facility subsequent to the non-conforming service by reserving the infrastructure before, during, and/or after the scheduling/performance of the non-conforming service. In some implementations, for example where the non-conforming service is requested in response to a deviation caused by a deviating vehicle provider, the infrastructures attribute can be indicative of a deviation offset such as, for example, a guarantee provided by the deviating aerial vehicle provider to use the infrastructure. In this manner, the service entity computing system can pool computing resources (e.g., infrastructure devices) from a number of different vehicle providers to offset computing resource inefficiencies caused by a non-conforming service and/or flight deviation.

The service entity computing system can determine the one or more offsetting attributes based, at least in part, on the at least one flight type of the non-conforming service. By way of example, the at least one flight type can include a deadhead flight and, in response, the service entity computing system can determine one or more offsetting attributes that include an anticipated capacity for a flight subsequent to the non-conforming service to cover one or more expenses associated with the deadhead flight. As another example, the at least one flight type can include a restricted facility flight and, in response, the service entity computing system can determine one or more offsetting attributes that include infrastructure attributes for a restricted facility. The infrastructure attributes, for example, can be indicative of infrastructure at the restricted facility such as, for example, one or more energy-replenishment devices at the restricted facility, an availability of the one or more energy-replenishment devices, and/or a compensation for using the one or more energy-replenishment devices. For example, the one or more energy-replenishment devices can include one of more fueling and/or charging devices at the restricted facility and the one or more offsetting attributes can include a guarantee to pay, reserve, etc. the one or more fueling and/or charging devices at the restricted facility to replenish the energy of an aerial vehicle after and/or before the non-conforming service.

In some implementations, the one or more offsetting attributes for the non-conforming service can be determined based, at least in part, on the historical data associated with the at least one aerial vehicle provider. For example, the historical data can be indicative of one or more previous non-conforming service requests provided to the aerial vehicle provider. The one or more offsetting attributes can be determined based on an acceptance and/or rejection rate associated with one or more previous offsetting attributes corresponding to the previous non-conforming service requests and/or any other feedback data received and/or determined from previous interaction with the aerial vehicle provider.

The service entity computing system can provide the request to the at least one aerial vehicle provider and receive a vehicle provider response to the request. The vehicle provider response can include at least one of an acceptance and/or a denial of the request to schedule the non-conforming service. In response to a denial of the request, the service entity computing system can generate another request for one or more of the other aerial vehicle providers and/or optimize the one or more multi-modal transportation itineraries without the non-conforming service. In response to an acceptance of the request, the service entity computing system can receive non-conforming service data indicative of a scheduled flight from the aerial vehicle provider. The service entity computing system can generate one or more multi-modal transportation itineraries based on the non-conforming service data.

In addition, or alternatively, the service entity computing system can perform one or more offsetting actions to provide the offsetting attributes to the aerial vehicle provider in response to receiving an acceptance of the non-conforming service request. This can include booking one or more passengers for the flight subsequent to the non-conforming service before, during, and/or after the performance of the non-conforming service, providing compensation for the performance of the non-conforming service, providing a deviation offset to a deviating aerial vehicle provider, reserving and/or otherwise facilitating the use of third-party infrastructure at an unaffiliated aerial transportation facility, and/or any other action to initiate the performance of one or more offsetting attributes.

Example aspects of the present disclosure can provide a number of improvements to computing technology such as, for example, multi-modal transportation technology. For instance, the systems and methods of the present disclosure provide an improved approach for collaborating with a number of disparate computing systems to optimize multi-modal transportation itineraries based on real-time and predicted demand. The systems and methods of the present disclosure can provide for the movement of aerial vehicles (e.g., despite vehicle provider preferences) to service anticipated demand. The systems can methods provided herein can increase the availability, accessibility, and efficiency of transportation services. This in turn, allows for a reduction in resources expended to schedule, provide, and monitor multi-modal transportation services by dispatching aerial vehicles based on demand. The systems and methods of the present disclosure can leverage newly available scheduling preferences and demand information to tailor flight requests to a vehicle provider. The ability to pre-plan flights in this way enables a ride-sharing service entity to pool computing resources across a number of vehicle providers to dynamically service multi-modal transportation demand. Moreover, a service entity can leverage computing resources of deviating vehicle providers to reduce scheduling inefficiencies caused by the deviating vehicle provider. In the manner, the systems can methods provided herein enable the more efficient use of computing resources across a number of different multi-modal service providers involved in providing the multi-modal transportation services.

For example, a computing system can obtain multi-modal transportation service data indicative of a plurality of multi-modal transportation services. The computing system can obtain flight schedule(s) for facilitating the multi-modal transportation services. The flight schedule(s) can be provided by aerial vehicle provider(s) associated with one or more scheduling preferences. The computing system can determine a non-conforming service that violates a scheduling preference of an aerial vehicle provider. The computing system can generate a flight request to schedule the non-conforming service with one or more offsetting attributes. And, the computing system can provide the request to the vehicle provider. In this manner, the computing system(s) described herein employ improved collaboration techniques to optimally generate, schedule, maintain, and initiate multi-modal transportation services. To do so, the computing system(s) can accumulate and distribute newly available information such as, for example, the one or more scheduling preference(s), demand data indicative of real-time and predicted demand for multi-modal transportation services, non-conforming service requests, one or offsetting attributes, etc. By leveraging such data, the computing system(s) can anticipate a demand at one or more locations, generate one or more flights to accommodate the demand, and incentivize different aerial vehicle providers to schedule the flight despite scheduling preferences of the aerial vehicle providers. In this manner, the systems and methods of the present disclosure can enable a service entity to anticipate and accommodate a greater number of transportation services. This, in turn, increases the accessibility of transportation services, while enabling the computing system to avoid computational waste by ensuring that computing resources expended by a non-conforming service can be offset by actions (e.g., a subsequent flight, etc.) taken after the non-conforming service.

In addition, the computing system can obtain multi-modal transportation service data indicative of a plurality of multi-modal transportation services and flight data from one or more aerial vehicle providers. The flight data can be indicative of a number of aerial vehicles at one or more times for facilitating one or more aerial transportation services and can be associated with privileges. The computing system can generate one or more multi-modal transportation itineraries based, at least in part, on the multi-modal transportation service data and the flight data. The computing system can determine a deviation associated with the flight data from the at least one aerial vehicle provider and generate one or more modified multi-modal transportation itineraries based, at least in part, on the deviation and the one or more multi-modal transportation itineraries. The computing system can generate a deviation offset based, at least in part, on the one or more modified itineraries and the one or more permissions. And, the computing system can provide the deviation offset to the at least one vehicle provider. In this way, the computing system(s) described herein employ improved collaboration techniques to anticipate and mitigate transportation delays by leveraging computing resources associated with a number of different vehicle providers. To do so, the computing system(s) accumulate and distribute newly available information such as, for example, the flight data, deviation data, deviation offsets, privileges, etc. By leveraging such data, the computing system(s) can generate and modify multi-modal transportation itineraries to accommodate one or more deviations from an expected number of aerial vehicles. The computing system(s) can utilize privileges granted by the vehicle providers to offset inefficiencies caused by a respective vehicle provider. Such privileges can enable the computing system(s) to utilize computing resources of a deviating vehicle provider to compensate for an inefficient use of computing resources to modify affected transportation services. By pooling computing resources from a number of vehicle providers, the computing system(s) can avoid wasting flight resources, infrastructural resources, and/or other computing resources otherwise caused by unpredictable occurrences inherent in aerial transportation services.

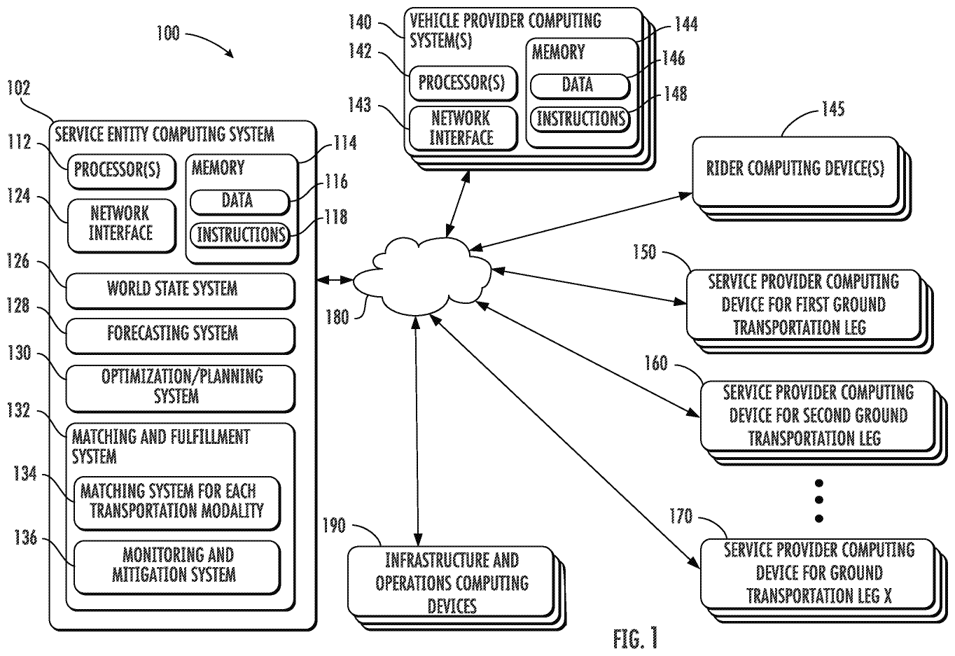

FIG. 1 depicts a block diagram of an example computing system 100 according to example embodiments of the present disclosure. The system 100 can include a service entity computing system 102 and a vehicle provider computing system 140 that can operate (e.g., collectively, or individually) to control, route, monitor, and/or communicate with aircraft (e.g., VTOL aircraft) and/or one or more other transportation service entities to facilitate a multi-modal transportation service. These operations can be performed as part of a multi-modal transportation service for riders, for example, including travel by ground vehicle and travel by aircraft (e.g., VTOL aircraft).

The service entity computing system 102 can be communicatively connected over a network 180 to the vehicle provider computing system(s) 140, one or more rider computing devices 145, one or more service provider computing devices 150 for a first ground transportation leg, one or more service provider computing devices 160 for a second ground transportation leg, one or more service provider computing devices 170 for an Nth ground transportation leg, and/or one or more infrastructure and operations computing devices 190. For example, the vehicle provider computing system(s) 140 can include one or more communication interfaces 143 communicatively connected to the service entity computing system 102 and the service entity computing system 102 can include one or more communication interfaces 124 communicatively connected to the vehicle provider computing system(s) 140.

Each of the computing devices 145, 150, 160, 170, 190 can include any type of computing device such as a smartphone, tablet, hand-held computing device, wearable computing device, embedded computing device, navigational computing device, vehicle computing device, etc. A computing device can include one or more processors and a memory (e.g., similar to as will be discussed with reference to processors 112, 142 and memory 114, 144). Although service provider devices are shown for N different transportation legs, any number of different transportation legs can be used, including, for example, less than the three illustrated legs (e.g., two legs can be used).

The computing systems 102, 140 can include one or more processors 112, 142 and a memory 114, 144. The one or more processors 112, 142 can be any suitable processing device (e.g., a processor core, a microprocessor, an ASIC, a FPGA, a controller, a microcontroller, etc.) and can be one processor or a plurality of processors that are operatively connected. The memory 114, 144 can include one or more non-transitory computer-readable storage media, such as RAM, ROM, EEPROM, EPROM, one or more memory devices, flash memory devices, etc., and combinations thereof.

The memory 114, 144 can store information that can be accessed by the one or more processors 112, 142. For instance, the memory 114, 144 (e.g., one or more non-transitory computer-readable storage mediums, memory devices) can store data 116, 146 that can be obtained, received, accessed, written, manipulated, created, and/or stored. In some implementations, the computing system(s) 102, 140 can obtain data from one or more memory device(s) that are remote from the system(s) 102, 140.

The memory 114, 144 can also store computer-readable instructions 118, 148 that can be executed by the one or more processors 112, 142. The instructions 118, 148 can be software written in any suitable programming language or can be implemented in hardware. Additionally, or alternatively, the instructions 118, 148 can be executed in logically and/or virtually separate threads on processor(s) 112, 142. For example, the memory 114, 144 can store instructions 118, 148 that when executed by the one or more processors 112, 142 cause the one or more processors 112, 142 to perform any of the operations and/or functions described herein.

The network(s) 180 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 180 can be accomplished, for instance, via a network interface using any type of protocol, protection scheme, encoding, format, packaging, etc.

The service entity computing system 102 can receive a request (e.g., via network(s) 180) from a rider (e.g., via the rider computing device(s) 145) that requests for the service entity computing system 102 to facilitate a transportation service for the rider from an origin location to a destination location. For example, the rider can interact with a dedicated application on the rider computing device 145 (e.g., smartphone, tablet, wearable computing device, or the like) to initiate the request. By way of example, the rider can interact with the rider computing device 145 by opening the dedicated application and/or initiating a booking process via the dedicated application. The service entity computing system 102 can initiate the generation of a plurality of multi-modal transportation itineraries in response to the rider opening the dedicated application and/or otherwise initiating a booking process.

In response to the request, the service entity computing system 102 can generate at least one itinerary that includes transportation of the rider from the origin location to the destination location. Specifically, the service entity computing system 102 can generate an end-to-end multi-modal transportation itinerary including a plurality of transportation legs that include transportation via a plurality of different transportation modalities. The end-to-end multi-modal transportation itinerary can include two or more transportation legs that include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities. Example aircrafts can also include helicopters and other vertical take-off and landing aircraft (VTOL) such as electric vertical take-off and landing aircraft (eVTOL). The vehicles can include non-autonomous, semi-autonomous, and/or fully-autonomous vehicles.

In some implementations, the service entity computing system 102 can facilitate the ability of the rider to receive transportation on one or more of the transportation legs included in the multi-modal transportation itinerary. As one example, the service entity computing system 102 can interact with one or more service provider computing device(s) 150, 160, 170 to match the rider with one or more transportation service providers. As another example, the service entity computing system 102 can book or otherwise reserve a seat in, space on, or usage of one or more of the transportation modalities for the rider. Additionally, or alternatively, the service entity computing system 102 can collaborate with the vehicle provider computing system 140 to provide information for options to be provided by the vehicle provider computing system 140 for one or more of the transportation legs.

More particularly, in some implementations, the service entity computing system 102 can respond to the rider's request by determining whether it is better to fulfill the rider's request using a single transportation modality or using multiple transportation modalities. As one example, the service entity computing system 102 can evaluate the rider's current location, origin location, and/or destination location to determine which modalities of transportation are usable at such location (e.g., able to access such locations). For example, the location(s) can be checked against a list of permitted locations that have been approved for participation in various types of modalities (e.g., flight modalities for the purpose of generating a multi-modal trip itinerary). As another example, the service entity computing system 102 can evaluate (e.g., generate) one or more itineraries that are single-modal and one or more itineraries that are multi-modal (e.g., inclusive of various combinations of different transportation modalities). The service entity computing system 102 can compare the generated single- and multi-modal itineraries to determine whether it is appropriate to suggest a single- or multi-modal itinerary to the rider. For example, one or more of the best itineraries (e.g., as evaluated based on various characteristics such as cost, time, etc.) can be suggested to the rider. The rider can select, via the rider computing device 145, one of the suggested itineraries to receive transportation services in accordance with the selected itinerary.

In some implementations, the service entity computing system 102 can continually re-evaluate various itineraries (e.g., single- and/or multi-modal itineraries) before and even during completion of a selected itinerary. If an improved itinerary becomes available (e.g., which may include changing from a single-modal itinerary to a multi-modal itinerary if, for example, a seat on a flight becomes available) the service entity computing system 102 can suggest the improved itinerary for selection by the rider. In some implementations, if the rider selects, via the rider computing device(s) 145, the improved itinerary during completion of an existing itinerary, the service entity computing system 102 can facilitate switching to the updated itinerary, including, for example, re-routing a service provider that is currently transporting the rider to an alternative, updated destination.

Thus, in response to the rider's request, the service entity computing system 102 can perform one or more algorithms to generate a multi-modal transportation itinerary for the rider. As an example, in some implementations, the service entity computing system 102 can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first).

As one particular example, in some implementations, the service entity computing system 102 can initially analyze a first transportation modality that is the most efficient (e.g., in terms of travel speed and/or cost) transportation modality which operates according to a fixed infrastructure. As an example, for most longer transportation services and for the mix of different modalities described above, flight modalities can both be the most efficient transportation modality (e.g., in terms travel speed/time) while also operating according to a fixed infrastructure. By first analyzing the most efficient transportation modality which operates according to a fixed infrastructure, the service entity computing system 102 can seek to identify an important transportation leg around which the remainder of the itinerary can be stitched.

More particularly, in some implementations, one or more of the transportation modalities can operate according to or within a fixed transportation infrastructure in which the ability of passengers to embark and disembark vehicles is constrained to a defined set of transportation nodes. As one example, in some implementations, aerial vehicles that operate within the ride sharing network can be constrained to load and unload passengers only at a defined set of physical take-off and/or landing areas which may in some instances be referred to as aerial transportation facilities. To provide an example, a large urban area may have dozens of transportation nodes located at various locations within the urban area. Each transportation node can include one or more landing pads and/or other infrastructure to enable passengers to safely embark or disembark from aerial vehicles. The take-off and/or landing areas of the transportation nodes can be located at ground level and/or elevated from ground-level (e.g., atop a building).

Transportation nodes can include charging equipment, re-fueling equipment, and/or other infrastructure for enabling aerial operation. The infrastructure and operations computing devices 190 can be any form of computing device used by and/or at the infrastructure or operations personnel including, for example, devices configured to perform passenger security checks, luggage check in/out, re-charging/re-fueling, vehicle climate control, safety briefings, vehicle check in/out, and/or the like.

In some implementations, a vehicle provider (e.g., service entity provider associated with the service entity computing system 102, third-party vehicle provider associated with vehicle provider computing system(s) 140, etc.) can be affiliated with one or more of the defined set of physical service areas (e.g., take-off and/or landing areas for aerial modalities, etc.) and/or infrastructure and operations computing device(s) 190 thereof. An affiliated transportation facility, for example, can include infrastructure and/or space (e.g., parking areas, take-off/landing areas, etc.) provided, maintained, and/or owned by a respective affiliated vehicle provider. An affiliated vehicle provider can be configured to store (e.g., park, etc.), service, and/or otherwise facilitate a transportation service from the one or more affiliated transportation facilities. The defined set of physical service areas (e.g., take-off and/or landing areas) can include, for example, one or more public or private airports. A public airport, for example, can include one or more areas that are leased to a respective affiliated vehicle provider. A private airport can be at least partly owned, leased, and/or maintained by a respective affiliated vehicle provider.

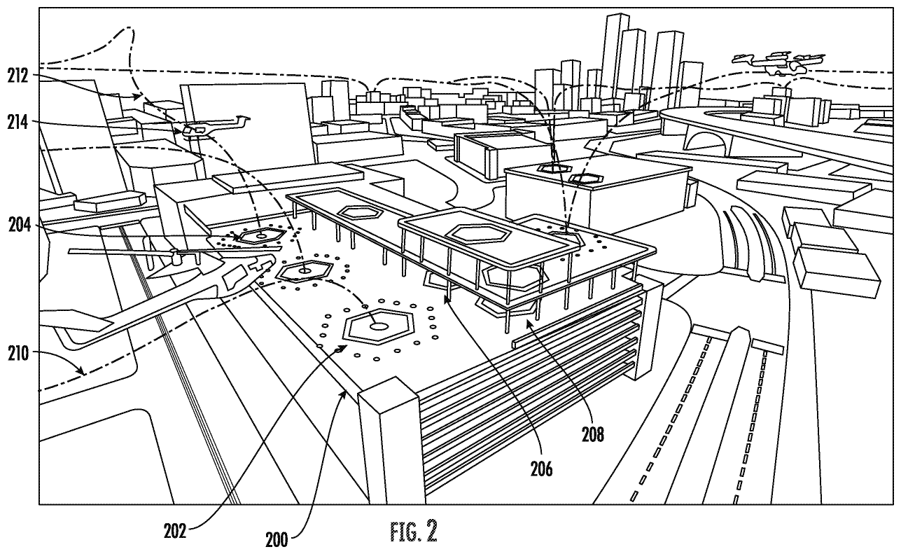

As an example, FIG. 2 depicts a graphical diagram of an example transportation node according to example embodiments of the present disclosure. The example transportation node 200 can include a transportation facility for facilitating the transportation service of a plurality of different modality as described herein. The transportation modalities, for example, can include one or more aerial modalities associated with a plurality of aerial transportation facilities; one or more aquatic modalities associated with one or more waterside transportation facilities; one or more subterranean modalities associated with one or more underground facilities; one or more ground-level modalities associated with one or more ground level facilities, etc. The example transportation node 200 includes one example transportation facility for an aerial modality for exemplary purposes only. Transportation nodes for the other transportation modalities described herein can include variations on the example transportation node 200.

The example transportation node 200 can include a number of take-off/landing pads such as pads 202 and 204. In addition, the example transportation node 200 can include a number of vehicle parking locations such as parking locations 206 and 208. For example, re-fueling or re-charging infrastructure may be accessible at each parking location. Flight trajectories into and out of the transportation node 200 can be defined, configured, assigned, communicated, etc. FIG. 2 illustrates a number of flight trajectories including, for example, trajectories 210 and 212. The trajectories can be fixed or can be dynamically computed. The trajectories can be computed by the aircraft or can be centrally computed and then assigned and communicated to the aircraft. As one example, FIG. 2 illustrates a helicopter 214 taking off from the pad 204 according to the trajectory 212.

Turning back to FIG. 1, the service entity computing system 102 can initially analyze the transportation modality that is the most supply-constrained. More particularly, certain transportation modalities may be more supply-constrained than other modalities in terms of number of available service providers and/or average number of services provided daily. For example, at least in the near future and due to the relatively larger challenge and cost involved with operating aerial vehicles, flight modalities are likely to be more supply-constrained than ground-based modalities such as cars. Because the most supply-constrained modality represents the most option-limiting aspect of building different itineraries, by first analyzing the most supply-constrained modality the service entity computing system 102 can more efficiently generate the multi-modal transportation itinerary.

The service entity computing system 102 can initially identify any fixed transportation nodes (e.g., aerial transportation facilities) associated with a transportation modality (e.g., aerial transportation modality) that are relevant to the rider's request. For example, the service entity computing system 102 can identify any nodes that are within a threshold distance from the origin location as candidate departure nodes. Likewise, the service entity computing system 102 can identify any nodes that are within a threshold distance from the destination location as candidate arrival nodes.

The service entity computing system 102 can include and/or be associated with a number of subsystems (e.g., world state system 126, forecasting system 128, optimization/planning system 130, matching and fulfillment system 132, etc.) configured to provide a plurality of backend services to facilitate a transportation service. By way of example, the optimization/planning system 130 can provide a backend itinerary service to generate one or more multi-modal transportation itineraries for a rider in accordance with the procedures described herein. The systems 126-132 can cooperatively interoperate (e.g., including supplying information to each other).

More particularly, the world state system 126 can operate a state monitoring service to maintain data descriptive of a current state of the world. For example, the world state system 126 can generate, collect, and/or maintain data descriptive of planned itineraries; pre-determined transportation plans (e.g., flight plans) and assignments; current requests; current ground transportation service providers; current aerial transport facility operational statuses (e.g., including re-charging or re-fueling capabilities); current aerial vehicle statuses (e.g., including current fuel or battery level); current pilot statuses; current flight states and trajectories; current airspace information; current weather conditions; current communication system behavior/protocols; and/or the like. For instance, the world state system 126 can be configured to obtain world state data through communication (e.g., via an API platform) with one or more vehicles (e.g., via service provider device(s) 150, 160, 170), vehicle providers (e.g., vehicle provider computing system(s) 140), and/or any other transportation entity associated with the service entity computing system 102.

As another example, the forecasting system 128 can operate a forecasting service to generate predictions of transportation demand, weather forecasts, and/or any other future looking data helpful for completing a transportation service. The forecasting system 128 can generate predictions of the demand and supply for transportation services at or between various locations over time. The forecasting system 128 can also generate or supply weather forecasts. The forecasts made by the system 128 can be generated based on historical data and/or through modeling of demand and supply.

The optimization/planning system 130 can generate transportation plans for various transportation assets and/or can generate itineraries for riders. For example, the optimization/planning system 130 can perform and/or facilitate flight planning. As another example, the optimization/planning system 130 can plan or manage/optimize itineraries which include interactions between riders and service providers or vehicle providers across multiple modes of transportation. The matching and fulfillment system 132 can match a rider with a service provider for each of the different transportation legs. For example, each respective matching system 134 can communicate with the corresponding service provider computing devices 150, 160, 170 via one or more APIs or connections. Each matching system 134 can communicate trajectories and/or assignments to the corresponding service providers or vehicle providers. Thus, the matching and fulfillment system 132 can perform or handle assignment of ground transportation, flight trajectories, take-off/landing, etc.

The monitoring and mitigation system 136 can perform monitoring of rider itineraries and can perform mitigation when an itinerary is subject to significant delay (e.g., one of the legs fails to succeed). Thus, the monitoring and mitigation system 136 can perform situation awareness, advisories, adjustments, and the like. The monitoring and mitigation system 136 can trigger alerts and actions sent to the systems 140 or devices 145, 150, 160, 170, and 190. For example, entities such as riders, service providers, and/or operations personnel can be alerted when a certain transportation plan has been modified and can be provided with an updated plan/course of action. Thus, the monitoring and mitigation system 136 can have additional control over the movement of aerial vehicles, ground vehicles, air traffic controllers, pilots, and riders.

The service entity computing system 102 (and/or one or more subsystems 126-132 thereof) can interact with various vehicle providers (e.g., third-party vehicle providers, service entity vehicle providers, etc.). To do so, the service entity computing system 102 can include an application programming interface platform to facilitate services between the service entity infrastructure (e.g., the services of the service entity computing system 140, service entity vehicle providers, etc.) and third-party vehicle providers (e.g., vehicle provider computing systems 140, etc.). The API platform can include one or more functional calls to the backend services of the service entity computing system 140. By way of example, the one or more functional calls can be configured to communicate a request and/or data between the one or more subsystems (e.g., world state system 126, forecasting system 128, optimization/planning system 130, etc.) of the service entity computing system 102 and one or more transportation entities associated with a transportation service (e.g., aerial vehicles, air traffic controllers, ground vehicles, pilots, passengers, etc.).

In some instances, the service entity computing system 102 may have at least some control over transportation services provided by service providers on at least some of the transportation modalities and, therefore, may pre-determine a number of planned transportation services by the service providers. For example, in some implementations, the operators of one or more aerial vehicles can be controlled by (e.g., contracted with) the service entity computing system 102. In such a case, the service entity computing system 102 can generate (e.g., on a daily basis) an initial pre-defined set of flight plans for service entity aerial vehicles and can add or remove passengers from each planned flight. In addition, the service entity computing system 102 can dynamically optimize planned transportation services by the service entity to account for real-time changes in rider availability and demand. For example, the service entity computing system 102 can dynamically modify the pre-determined flight plans (e.g., delay a planned flight departure by five minutes and/or change a planned flight to an alternative arrival transportation node).

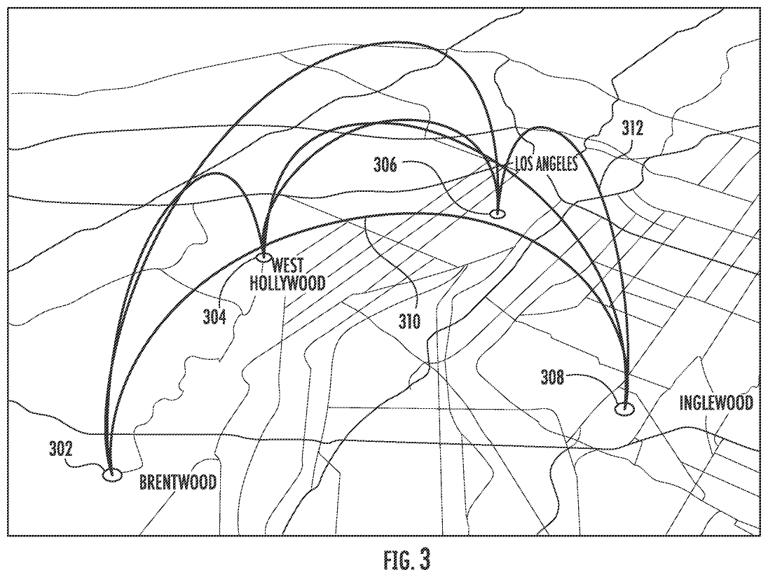

As an example, FIG. 3 depicts a graphical diagram of an example set of transportation plans between an example set of transportation nodes according to example embodiments of the present disclosure. In particular, FIG. 3 provides a simplified illustration of an example fixed infrastructure associated with flight-based transportation in an example metropolitan area. The flight-based transportation plans are provided for exemplary purposes only. Different variations of the set of transportation plans are possible for any transportation modality (e.g., aquatic modalities, subterranean modalities, ground-level modalities, etc.) between respective transportation facilities for facilitating the transportation modalities as described herein.

As illustrated in FIG. 3, there can be four transportation nodes which may be referred to as “aerial transportation facilities.” For example, a first transportation node 302 is located in a first neighborhood of the metropolitan area, a second transportation node 304 is located in a second neighborhood, a third transportation node 306 is located in a third neighborhood, and a fourth transportation node 308 is located in a fourth neighborhood. The location and number of transportation nodes is provided only as an example. Any number of transportation nodes at any different locations can be used. Flights can be available (e.g., may be pre-planned, dynamically planned, etc.) between certain pairs of the transportation nodes. For example, a flight path 310 can exist between the first transportation node 302 and the fourth transportation node 308. Likewise, a flight path 312 can exist between the fourth transportation node 308 and the third transportation node 306.

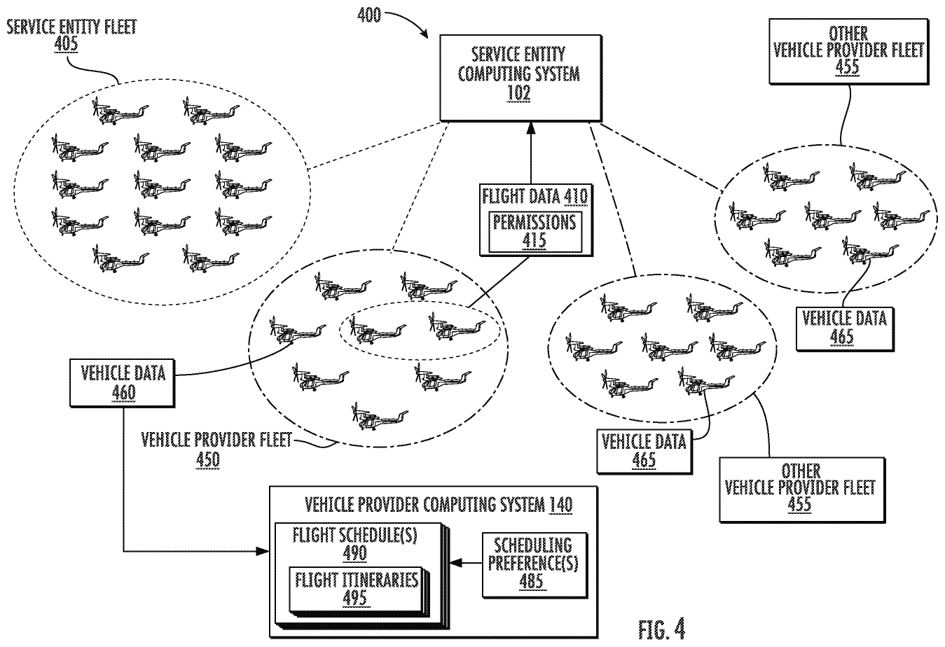

The service entity computing system can collaborate with one or more vehicle provider computing system(s) to obtain one or more transportation schedule(s) for facilitating the one or more transportation services. For example, FIG. 4 depicts an example vehicle provider ecosystem 400 according to example embodiments of the present disclosure. The service entity computing system 102 can utilize service entity vehicle(s) of the service entity fleet 405 and/or one or more third-party vehicle(s) from one or more third-party vehicle provider fleet(s) (e.g., third-party aerial vehicle provider fleet(s) 450, 455, etc.) to perform one or more transportation services (e.g., aerial transportation services throughout an operational time period such as an hour, day, week, etc.). The number of vehicles (e.g., aerial vehicles, etc.) available from the one or more third-party vehicle provider(s) (e.g., vehicle provider associated with vehicle provider computing system 140) can be independently available to a plurality of different ride-sharing platforms.

FIG. 4 depicts a plurality third-party aerial vehicle provider(s) as one exemplary variation of a plurality of different possible third-party vehicle provider(s) associated with a plurality of different transportation modalities as described herein. The third-party vehicle provider(s), for example, can include one or more third-party aquatic vehicle provider(s) associated with third-party aquatic vehicle provider fleet(s); one or more third-party subterranean vehicle provider(s) associated with third-party subterranean vehicle provider fleet(s); one or more third-party ground-level vehicle provider(s) associated with third-party ground-level vehicle provider fleet(s), etc. The example third-party aerial vehicle provider fleet(s) 450, 455 includes example vehicle provider fleet(s) for an aerial modality for exemplary purposes only. Vehicle provider fleet(s) for the other transportation modalities described herein can include variations on the example third-party aerial vehicle provider fleet(s) 450, 455.

As an example, a vehicle provider of any modality can be associated with data indicative of one or more permission(s). The vehicle provider(s) can determine one or more transportation schedules based on vehicle data associated with a respective fleet of vehicles. The vehicle provider(s) can determine the one or more transportation schedules based on scheduling preference(s) of the vehicle provider. The vehicle provider(s) can receive a request for a non-conforming service that violates at least one scheduling preference. The vehicle provider(s) can accept or decline to perform the requested non-conforming service.

As a particular example, a vehicle provider (e.g., associated with vehicle provider computing system 140) and/or the other aerial vehicle providers can be associated with a vehicle provider fleet 450 and/or a respective other vehicle provider fleet 455. Each fleet 450, 455 can include one or more aerial vehicles associated (e.g., managed, operated, scheduled, etc.) with a respective vehicle provider. The aerial vehicle(s) can include one or more autonomous, semi-autonomous, and/or non-autonomous aerial vehicles. The vehicle(s) can include any type of aircraft such as, for example, helicopters and/or other vertical take-off and landing aircraft (VTOL) including electric vertical take-off and landing aircraft (eVTOL). For instance, the vehicles can include one or more electric vehicles such as, for example, electric vertical and take-off and landing vehicles. The electric vehicles can be powered by one or more electric batteries.

The vehicle provider computing system 140 can be configured to manage, maintain, and/or schedule the fleet of aerial vehicles 450 across a plurality of aerial transportation facilities based on information associated with the vehicles and/or vehicle provider. In addition, or alternatively, the service entity computing system 102 can be configured to manage, maintain, and/or schedule the fleet of aerial vehicles 450. For example, in some implementations, the service entity computing system 102 can perform one or more of the functions of the vehicle provider computing system 140 as described herein.

In some implementations, a vehicle provider (e.g., vehicle provider computing system 140) can provide flight data 410 indicative of a number of aerial vehicles at one or more times for facilitating one or more aerial transportation services and the service entity computing system 102 can generate flight schedules based on the flight data 410. In some implementations, the flight data 410 can be associated with one or more permission(s) 415 corresponding to at least one of the vehicle provider(s). The permission(s) 415, for example, can include a compensation for a deviation to the flight data 410. By way of example, the permission(s) can be indicative of one or more covered inefficiencies for failing to achieve a number of aerial vehicles promised by the service provider at a respective time (e.g., at a time step, during a time range, etc.). For instance, the permission(s) 415 can be included with the flight data 410 to reduce wasted computing resources due to the service provider's failure to provide a number of aerial vehicles. In the event that the vehicle provider fails to achieve a number of promised vehicles, the permission(s) 415 can enable the service entity computing system 102 to offset inefficiencies (e.g., computing resources expended to mitigate the deviation, etc.) for mitigating transportation delays caused by the deviation from the number of vehicles.

In addition, or alternatively, the vehicle provider(s) (e.g., vehicle provider computing system 140) can provide flight schedule(s) 490 indicative of a plurality of scheduled flight itineraries 495. For example, a vehicle provider computing system can be configured to manage, maintain, and schedule the fleet of aerial vehicles across a plurality of aerial transportation facilities based on information associated with the vehicles (e.g., vehicle data 460), multi-modal transportation services data (e.g., described in further detail herein), and/or vehicle provider preferences associated with the respective aerial vehicle provider. For example, each aerial vehicle provider of the vehicle provider(s) can be associated with one or more scheduling preference(s) 485. The scheduling preference(s) 485 can include a set of guidelines by which the vehicle provider computing system 140 can schedule flight itineraries 495. The set of guidelines, for example, can be individually (and/or commonly) determined by a respective aerial vehicle provider (and/or a group of aerial vehicle providers, etc.) to maximize one or more desired flight outcomes such as, for example, one or more revenue goals, servicing goals, and/or passenger satisfaction goals of the respective aerial vehicle provider.

By way of example, the scheduling preference(s) 485 can include at least one of a deadhead avoidance preference, a route preference, an aerial facility preference, a layover preference, and/or any other preference guiding the scheduling practices of an aerial vehicle provider. For example, the scheduling preference(s) can include a deadhead avoidance preference to maximize one or more revenue goals of the aerial vehicle provider. A deadhead flight, for example, can include a flight performed with little to no passengers for the purpose of moving an aerial vehicle from one aerial transportation facility to another. A revenue goal can include a minimum revenue generation for each scheduled flight. Thus, to maximize the revenue goal, a vehicle provider computing system 140 can follow a deadhead avoidance preference to minimize a number of deadhead flights scheduled throughout an operational period.

As another example, the scheduling preference(s) 485 can include an aerial facility preference to maximize one or more revenue, servicing, and/or passenger satisfaction goals of the aerial vehicle provider. For instance, the aerial facility preference can include a plurality of aerial transportation facilities approved for operation by the aerial vehicle provider. By way of example, the approved aerial transportation facilities can include one or more affiliated aerial transportation facilities that include infrastructure and/or space at least partly owned, leased, operated, and/or maintained by the aerial vehicle provider. The aerial facility preference can be indicative of one or more restricted (e.g., third-party, unaffiliated, etc.) aerial transportation facilities that are not affiliated with the aerial vehicle provider. By restricting the aerial transportation facilities to affiliated facilities, the aerial facility preference can be configured to maximize revenue (e.g., by minimizing the cost to maintain, store, etc. an aerial vehicle at a third-party facility), enhance servicing of an aerial vehicle (e.g., by using equipment owned/maintained by the aerial vehicle provider), and/or increase passenger satisfaction by using infrastructure affiliated with the aerial vehicle provider.

As yet another example, the scheduling preference(s) 485 can include a routing preference to maximize one or more revenue, servicing, or passenger satisfaction goals of the aerial vehicle provider. For instance, the routing preference can be indicative of a plurality of routes between affiliated aerial facilities. In addition, or alternatively, the routing preference can be indicative of one or more environment conditions, sky lanes, etc. that can be used to constrain scheduled routes for a scheduled flight. In addition, or alternatively, the scheduling preference(s) 485 can include a layover preference to maximize one or more revenue, servicing, or pilot health goals. For example, the layover preference can be indicative of a time threshold for one or more layover(s) between scheduled flights. By way of example, the time thresholds can include a minimum time threshold (e.g., a minimum amount of time for servicing an aerial vehicle, etc.) and/or a maximum time threshold (e.g., a maximum amount of time before scheduling an additional flight). The maximum time threshold, for example, can be indicative of a restriction on overnight layovers, etc.

In some implementations, the service entity computing system 102 can receive the vehicle provider preference(s) 485 associated with each aerial vehicle provider from a respective vehicle provider computing system 140. In addition, or alternatively, the vehicle provider preference(s) 485 can be inferred based on one or more flight schedule(s) 490 of a respective aerial vehicle provider. For example, each of the aerial vehicle provider(s) can be associated with historical data with the service entity. The aerial vehicle provider scheduling preference(s) 485 associated with the one or more aerial vehicle provider(s) can be determined based, at least in part, on the historical data. As an example, the historical data can include a plurality of sets of flight schedules for one or more historical operational time periods. The scheduling preference(s) 485 can be determined based on one or more attributes shared by one or more of the sets of flight schedules. By way of example, a scheduling preference indicative of a deadhead avoidance preference can be inferred based on a repeated absence of deadhead flights, etc.

Each vehicle provider computing system (e.g., computing system 140) can determine flight schedule(s) 490 in accordance with the respective preferences associated with the corresponding aerial vehicle provider. The flight schedule(s) 490 can include flight itineraries 495 for one or more available aerial vehicle(s) at one or more aerial transportation facilities during an operational time period. A flight itinerary, for example, can include one or more flight attributes. The one or more flight attributes can include a departure time, a departure location (e.g., the aerial transportation facility, a take-off location of the aerial transportation facility, etc.), a destination time (e.g., estimated time of arrival at a destination facility), a destination location, a vehicle capacity (e.g., number of passengers, etc.), a vehicle operator associated with the aerial transportation leg and/or any other information associated with the provision of an aerial transportation service.

The vehicle provider(s) (e.g., vehicle provider computing system 140) can provide the flight schedule(s) 490 (and/or flight data 410) to the service entity computing system 102. The service entity computing system 102 can generate one or more multi-modal transportation itineraries based, at least in part, on the flight schedule(s) 490 (and/or flight data 410) and multi-modal transportation service data. The service entity computing system can book and/or otherwise assign one or more riders to one or more of the flight itineraries 495 (e.g., of the received flight schedule(s) 490, the scheduled flight itineraries based on flight data 410, etc.) based, at least in part, on the multi-modal transportation itinerary(s).

By way of example, turning back to FIG. 1, in scenarios in which the aerial transportation modality operates according to a scheduled itinerary as described with reference to FIG. 4, after identifying relevant fixed transportation nodes associated with a multi-modal transportation service from an origin location to a destination location, the service entity computing system 102 can obtain one or more candidate flight itineraries associated with the multi-modal transportation service (e.g., the origin and/or destination location). The one or more candidate flight itineraries, for example, can include the flight schedules (e.g., flight schedules generated based on the flight data 410 and/or flight schedule(s) 490 obtained from a vehicle provider computing system 140 as depicted by FIG. 4) for each relevant fixed transportation node of the multi-modal transportation service.

The service entity computing system 102 can obtain the one or more candidate flight itineraries to identify candidate transportation plans between the relevant nodes. In some implementations, for example, the vehicle provider computing system 140 can provide a flight schedule (e.g., for each aerial vehicle, for each of the relevant nodes, etc.) to the service entity computing system 102. Additionally, or alternatively, the service entity computing system 102 can generate a flight schedule (e.g., for each vehicle, for each of the relevant nodes, etc.). The service entity computing system 102 can be configured to generate one or more multi-modal transportation itineraries based, at least in part, on the flight schedules and multi-modal transportation data. For example, the service entity computing system 102 can identify any transportation plans between one of the candidate departure nodes and one of the candidate arrival nodes which would satisfy a request for a multi-modal transportation itinerary, including, for example, any departure or arrival time requests. The service entity computing system 102 can stitch one or more additional legs to a respective transportation plan to generate a multi-modal transportation itinerary.

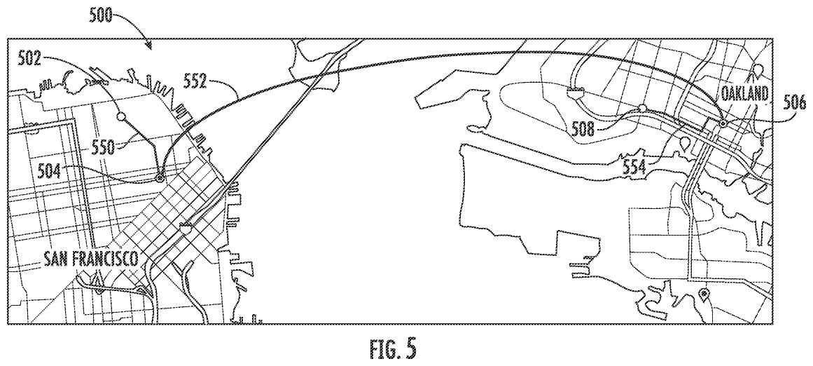

By way of example, FIG. 5 depicts a graphical diagram of an example multi-modal transportation service itinerary 500 according to example embodiments of the present disclosure. The multi-modal transportation itinerary 500 can include three transportation legs to transport the rider from an origin 502 to a destination 508. In particular, the multi-modal transportation itinerary 500 can include a first, ground-based (e.g., car-based) transportation leg 550 which transports the rider from the origin 502 to a departure transportation node 504; a second, flight-based transportation leg 552 which transports the rider from the departure transportation node 504 to an arrival transportation node 506; and a third, ground-based (e.g., car-based) transportation leg 554 which transports the rider from the arrival transportation node 506 to the destination 508. More particularly, the multi-modal transportation itinerary 500 can include a first ground transportation leg 550 from the origin location 502 to a first aerial transportation facility 504, an aerial transportation leg 552 from the first aerial transportation facility 504 to a second aerial transportation facility 506, and a second ground transportation leg 554 from the second aerial transportation facility 506 to the destination location 508. The aerial transportation leg 552 can include a selected plan (e.g., flight itinerary) of one or more candidate flight itineraries obtained from the vehicle provider computing system.

Turning back to FIG. 1, the service entity computing system 102 (e.g., optimization/planning system 130) can receive multi-modal transportation data indicative of one or more requests for a plurality of transportation services and generate the plurality of multi-modal transportation itineraries for facilitating the plurality of transportation services. An aerial vehicle can be assigned (e.g., by the service entity computing system 102, the vehicle provider computing system 140, etc.) to provide at least one leg of the multi-modal transportation itinerary. The service entity computing system 102 (e.g., matching and fulfillment system 132) and/or the vehicle provider computing system 140 can schedule, track the progress of, and/or modify each of the plurality of multi-modal transportation itineraries and/or one or more transportations legs thereof during an operational time period.

More particularly, the service entity computing system (e.g., an optimization/planning system) can receive multi-modal transportation services data indicative of one or more requests for a plurality of transportation services and generate the plurality of multi-modal transportation itineraries for facilitating the plurality of transportation services based on the one or more requests and the flight schedule(s) provided by the vehicle provider(s) and/or scheduled based on the flight data received from the vehicle provider(s). For example, the multi-modal transportation service data can be indicative of a plurality of multi-modal transportation services. The plurality of multi-modal transportation services can be associated with one or more aerial transportation services. As an example, each multi-modal transportation service can include at least two transportation legs. At least one of the at least two transportation legs can be facilitated by at least one of the one or more aerial transportation services (e.g., via a flight itinerary of the one or more flight schedules or scheduled based on the flight data).

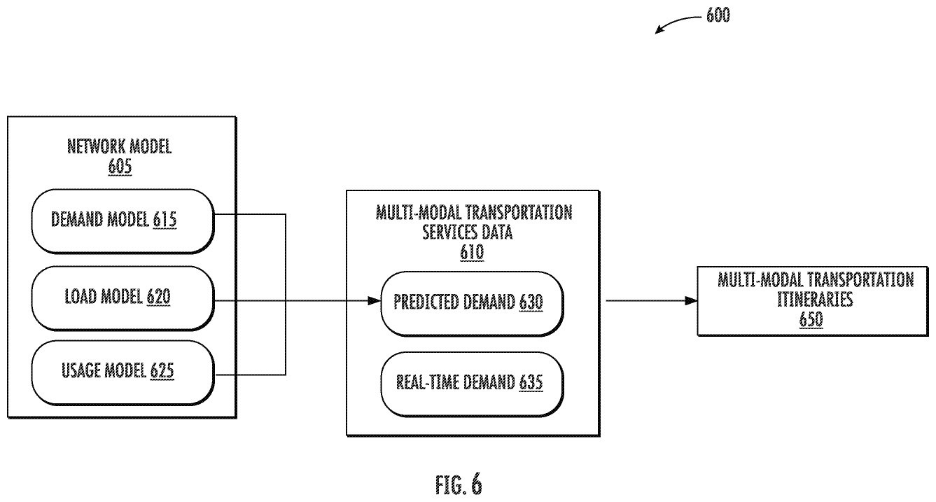

FIG. 6 depicts a data flow diagram 600 for generating multi-modal transportation itineraries according to example embodiments of the present disclosure. The data flow diagram 600 includes a network model 605 including sub models 615, 620, 625 configured to generate predicted demand data 630. The multi-modal transportation services data 610 can include the predicted demand data 630 and real-time demand data 635. The multi-modal transportation services data 610 can be utilized to generate multi-modal transportation itineraries 650.

More particularly, the multi-modal transportation services data 610 can include one or more anticipated, real-time, and/or scheduled requests for a multi-modal transportation service. For example, the multi-modal transportation services data 610 can include demand data including predicted demand data 630 (e.g., anticipated requests) and/or real-time demand data 635 (e.g., real-time/scheduled requests). As an example, the multi-modal transportation services data 610 can include demand data indicative of a real-time demand 635 (e.g., based on one or more real-time requests received at a current time) for one or more multi-modal transportation services, one or more scheduled multi-modal transportation services (e.g., based on one or more previously received requests received at a previous time), and/or any combination therebetween. In addition, or alternatively, the multi-modal transportation services data 610 can include predicted demand data 630 indicative of a plurality of anticipated aerial transportation services at one or more future times. The future times, for example, can include one or more time steps, periods, and/or ranges throughout an operational time period during which multi-modal transportation services are offered by the service entity.

By way of example, the multi-modal transportation services data 610 can include demand data indicative of a plurality of anticipated requests and/or one or more aspects thereof. For instance, the demand data can be indicative of the one or more anticipated transportation services throughout the operational time period. By way of example, the service entity computing system (e.g., the forecasting system) can include network model 605 configured to predict the plurality of anticipated requests based on historical and/or real-time data. In some implementations, the network model 605 can include one or more machine-learning models. The machine-learning models can include any machine-learning model (e.g., deep neural networks, convolutional neural networks, recurrent neural networks, recursive neural networks, decision trees, logistic regression models, support vector machines, etc.) and/or any other models configured to generate the demand data based on one or more inputs. In some implementations, the one or more machine-learning models can be learned (e.g., via one or more supervised training techniques) over a set of training data such as, for example, historical multi-modal transportation service data gathered over one or more previous operational time periods.

More particularly, the network model 605 can include a demand model 615, a load model 620, and/or an aerial transport usage model 625. The demand model 615 can be configured to determine an anticipated demand for aerial transportation services at one or more times (e.g., time steps, ranges, periods, etc.) throughout the operational time period. The load model 620 can be configured to estimate the maximum expected load factors at the one or more times (e.g., time steps, ranges, periods, etc.) throughout the operational time period. A load factor, for example, can identify a total expected weight to be transported. The aerial transport usage model 625 can be configured to estimate an expected number of flights for each aerial transportation facility and/or aerial vehicle of the fixed transportation infrastructure at one or more times (e.g., steps, periods, ranges, etc.) throughout the operational time period. For example, the aerial transportation usage model 625 can identify an expected number of aerial vehicles that will land, park, receive maintenance, and/or take off from each of a plurality of aerial transportation facilities.

In some implementations, the multi-modal transportation services data 610 can include itinerary data indicative of a number of services expected to be requested during the operational time period and/or one or more expected transportation request attributes of each of the expected service requests. The one or more expected transportation request attributes, for example, can include a type of requested service (e.g., single passenger transportation, group passenger transportation, item transportation, etc.), a time sensitivity of the requested service, a capacity sensitivity of the requested service, one or more locations (e.g., origin, destination, etc.) associated with the requested service, etc. For example, the attribute(s) can identify an aerial transportation facility (e.g., an origin facility, an intermediate facility, a destination facility, etc.) associated with each expected request, a number of services expected to be fulfilled by each aerial transportation facility, a number/type aerial vehicles needed to service each of the expected requests, a number/type of aerial vehicles at each aerial transportation facility needed to service the expected requests, etc.

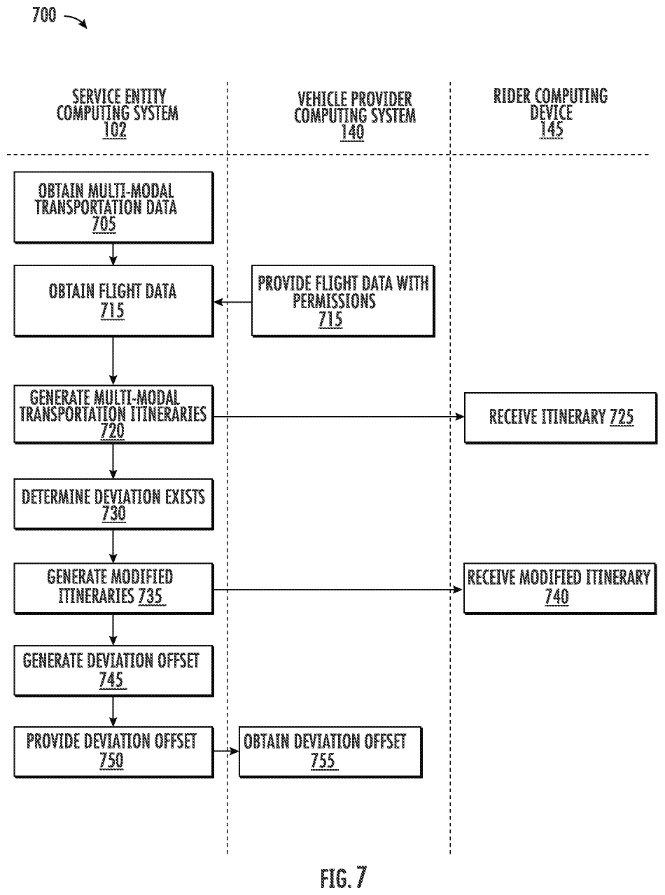

FIG. 7 depicts an activity diagram 700 for offsetting a deviation to data indicative of the number of vehicles at the one or more times for facilitating one or more transportation services from the at least one vehicle provider according to example embodiments of the present disclosure. The activity diagram 700 illustrates one or more interactions between the service entity computing system 102, a vehicle provider computing system 140, and a rider computing device 145 associated with a rider of a transportation service. The service entity computing system 102 can schedule one or more itineraries based on a number of vehicles identified by data provided by the vehicle provider(s) (e.g., vehicle provider computing system 140) and/or the multi-modal transportation service data. FIG. 7 depicts one scenario in which the vehicle provider is associated with an aerial modality for exemplary purposes only. It should be noted that the vehicle provider can include different vehicle providers associated with any transportation modality such as, for example, any of the transportation modalities described herein.

For example, at (705), the service entity computing system 102 can obtain the multi-modal transportation service data (e.g., in the manner described herein with reference to FIG. 6). At (710), the service entity computing system 102 can obtain flight data from the aerial vehicle provider(s) (e.g., vehicle provider computing system 140). For example, at (715), the vehicle provider computing system 140 can provide the flight data (e.g., with one or more permissions) to the service entity computing system 102. The service entity computing system 102 and schedule one or more flight itineraries to facilitate one or more real-time and/or predicted transportation services identified by the multi-modal transportation services data.

At (720), the service entity computing system 102 can generate one or more multi-modal transportation itineraries based, at least in part, on the multi-modal transportation service data and the flight data (e.g., service entity scheduled itineraries). The service entity computing system 102 can facilitate the provision of the multi-modal transportation itinerary(s) during an operational time period. For example, at (725), the service entity computing system 102 can provide data indicative of the multi-modal transportation itinerary(s) to one or more rider computing devices 145.

In some cases, at (720), the service entity computing system 102 can determine a deviation associated with the flight data from at least one aerial vehicle provider. The deviation, for example, can be indicative of a lower number of aerial vehicles at one or more time(s) during the operational time period than provided by the flight data. The deviation, for example, can be indicative of an unavailability of an aerial vehicle from the aerial vehicle provider to perform an aerial transportation leg of the one or more multi-modal transportation itinerary(s). In the event of the deviation, at (735), the service entity computing system 102 (e.g., a monitoring and mitigation system) can mitigate the aerial vehicle provider's failure to achieve the number of aerial vehicles identified by the flight data by generating one or more modified multi-modal transportation itineraries based, at least in part, on the deviation and/or the multi-modal transportation itinerary(s). The modified multi-modal transportation itinerary(s), for example, can include one or more different flight itineraries than the original multi-modal transportation itinerary(s).

By way of example, the service entity computing system 102 can generate the modified multi-modal transportation itinerary(s) by determining one or more multi-modal transportation itinerary(s) affected by the deviation. The affected multi-modal transportation itinerary(s), for example, can include multi-modal transportation itinerary(s) with an aerial transportation leg associated with the unavailable aerial vehicle. The service entity computing system 102 can obtain one or more additional flight itineraries and/or any other flight data indicative of one or more available aerial vehicles and, based on this data, modify the aerial transportation leg of the affected multi-modal transportation itinerary(s). This can include replacing the aerial transportation leg with an available aerial vehicle, a vehicle of another modality (e.g., book another ground transportation vehicle, extend the first transportation leg to cover the second transportation leg, etc.), etc. At (740), the service entity computing system 102 can provide data indicative of the modified multi-modal transportation itinerary to the one or more rider computing device(s) 145 associated with the affected multi-modal transportation itinerary(s).

At (745), the service entity computing system 102 can generate a deviation offset based, at least in part, on the one or more modified itineraries and/or the one or more permissions associated with the flight data. The deviation offset, for example, can include an inefficiency associated with the one or more modified multi-modal transportation itineraries. By way of example, the deviation offset can include one or more inefficiencies associated with replacing (and/or modifying) the second transportation leg of the affected multi-modal transportation itinerary(s). The one or more inefficiencies, for example, can include an increased cost to schedule an available aerial vehicle (e.g., based on limited time, different costs associated with a different aerial vehicle provider, etc.), a cost to facilitate the availability of an aerial vehicle (e.g., servicing costs to increase the servicing (e.g., fueling, charging) speed of an aerial vehicle, downstream costs for using the aerial vehicle, overtime for an operator of the aerial vehicle, etc.), a passenger cost for causing a transportation delay (e.g., a refund to a passenger issued by the service entity computing system to compensate for additional time caused by replacing an aerial transportation service with a ground transportation service, etc.), and/or any other inefficiencies associated with the modified multi-modal transportation itinerary(s).

The deviation offset can be based, at least in part, on the aerial vehicle provider and/or the permission(s) associated with the flight data. By way of example, each aerial vehicle provider can be associated with permission(s) enabling the service entity computing system 102 to offset the inefficiencies of a deviation caused by the aerial vehicle provider. The permission(s) can include one or more permitted deviation offsets and/or one or more restricted deviation offsets. As an example, the permission(s) can include permitted deviation offset(s) allowing the recovery of the inefficiencies of scheduling an available aerial vehicle and/or restricted deviation offsets restricting the recovery inefficiencies (e.g., refunds, etc.) associated with passenger compensation. In such a case, the service entity computing system 102 can generate deviation offsets based on the permitted deviations. At (750), the deviation offset can be provided to the vehicle provider computing system 140 such that the aerial vehicle provider can account for deviations caused by the aerial vehicle provider. At (755), the vehicle provider computing system 140 can obtain the deviation offset and accept and/or deny the offset.

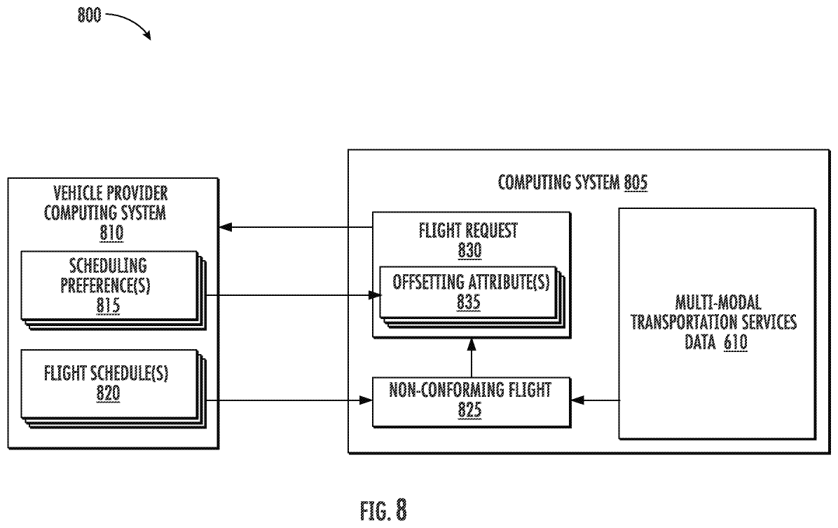

FIG. 8 depicts a data flow diagram 800 for generating a non-conforming service request according to example embodiments of the present disclosure. The data flow diagram 800 includes a computing system 805 (e.g., service entity computing system 102 of FIGS. 1, 4, 7, etc.) configured to generate a request (e.g., flight request 830) for a non-conforming service (e.g., non-conforming flight 825). The request can include one or more offsetting attribute(s) 835 tailored to one or more scheduling preference(s) 815 of a vehicle provider. The non-conforming service can be determined based on multi-modal transportation services data 610 and transportation schedule(s) (e.g., flight schedules 820) obtained from a vehicle provider computing system 810 (e.g., vehicle provider computing system(s) 140 of FIGS. 1, 4, 7, etc.). FIG. 8 depicts one example scenario in which the vehicle provider is associated with an aerial modality for exemplary purposes only. It should be noted that the vehicle provider can include different vehicle providers associated with any transportation modality such as, for example, any of the transportation modalities described herein.

The computing system 805 can optimize the scheduling of a plurality of multi-modal transportation itineraries based on the flight schedule(s) 820 provided by the vehicle provider computing system 810 (e.g., scheduled by the aerial vehicle providers in advance) and the real-time and/or anticipated transportation services (e.g., and/or one or more aspects thereof). For instance, the computing system 805 can attempt to generate a multi-modal transportation itinerary to maximize the number of real-time and/or anticipated services facilitated by the computing system 805. At times, the flight schedule(s) 820 provided by the vehicle provider computing system 810 (and/or one or more scheduling preference(s) 815 of the aerial vehicle provider(s)) can be a limiting factor to the optimization of multi-modal transportation itineraries. In such a case, the computing system 805 can utilize the multi-modal transportation services data 610 to generate a flight request 830 for a flight (e.g., that facilitates one or more multi-modal transportation services) that is not included in the flight schedule(s) 820.

For example, the computing system 805 can determine a non-conforming flight 825 (e.g., in addition to the scheduled flights) based, at least in part, on the one or more (e.g., real-time or predicted) aerial transportation services and/or the flight schedule(s) 820 obtained from the vehicle provider computing system 810. For instance, the computing system 805 can compare the multi-modal transportation services data 610 to the flight schedule(s) 820 (e.g., indicative of available flights) to determine whether an additional, unscheduled flight, may be beneficial for servicing the real-time and/or predicted demand. This can include, for example, a flight to compensate for an unavailable aerial vehicle due to a deviation (e.g., an aerial vehicle provider's failure to provide a number of anticipated vehicles (e.g., as indicated by flight data)). The non-conforming flight 825 can include a flight in addition to the flight itineraries of the flight schedule(s) 820 that violates at least one of the one or more scheduling preference(s) 815 for at least one of the aerial vehicle provider(s) (e.g., as indicated by the vehicle provider computing system 810).

As an example, the computing system 805 can identify one or more aerial transportation services (e.g., anticipated, or real-time) that are not achieved by the flight schedule(s) 820. The one or more aerial transportation services, for example, can include one or more anticipated and/or real-time aerial transportation services of a plurality of anticipated and/or real-time aerial transportation services identified by the multi-modal transportation services data 610. The computing system 805 can attempt to schedule a multi-modal transportation itinerary to facilitate each of the plurality of anticipated and/or real-time aerial transportation services identified by the multi-modal transportation services data 610. The one or more aerial transportation services can include services that cannot be facilitated based on the available flight itineraries of the provided flight schedule(s) 820 (and/or the scheduled flights based on flight data).

As an example, the one or more real-time and/or anticipated aerial transportation services can be indicative of a greater demand (e.g., due to an event, environmental conditions, etc.) than expected at one or more of the aerial transportation facilities. As another example, the one or more real-time and/or anticipated aerial transportation services can be indicative of one or more movement trends detected by the computing system 805. By way of example, the movement trend(s) can identify one or more expected return flights (e.g., for passengers that are engaged in an overnight trip, etc.), an increase in a number of flights between one or more aerial transportation facilities (e.g., due to a population increase, commercial developments, congestion, etc. proximate to at least one of the aerial transportation facility(s), etc.), and/or any other trend identifying travel patterns.

The computing system 805 can determine the non-conforming flight 825 to facilitate the one or more real-time and/or anticipated aerial transportation services. The non-conforming flight 825 can be associated with at least one of one or more flight types depending on a scheduling preference (e.g., of the scheduling preference(s) 815) violated by the non-conforming flight 825. The flight type(s), for example, can include a deadhead flight, a restricted route flight, a restricted facility flight, a layover flight, and/or any other flight that violates a scheduling preference of a respective vehicle provider. For example, a deadhead flight can violate a deadhead avoidance preference, a restricted route flight can violate the route preference, a restricted facility flight can violate an aerial facility preference, a layover flight can violate a layover preference, etc. By way of example, a deadhead flight can include a deadhead flight (e.g., to move an aerial vehicle to a high demand aerial transportation facility) or cause a subsequent deadhead flight (e.g., to service an immediate demand with no subsequent demand). For example, the non-conforming flight 825 can include a route to an aerial transportation facility corresponding to a number of aerial transportation services. In this manner, the computing system 805 can determine the non-conforming flight 825 to position aerial vehicles at high demand aerial transportation facilities despite one or more scheduling preference(s) 815.

As other examples, a restricted route flight can include a requested flight route that violates a route preference by causing an aerial vehicle to fly in undesirable environmental conditions (e.g., approved by the FAA standards, but restricted to increase passenger satisfaction, etc.) such as high turbulence, light rain, etc. In addition, or alternatively, the requested flight route can include one or more restricted (e.g., third-party, unaffiliated facilities) aerial transportation facilities as a waypoint. As another example, a restricted facility flight can request a flight that causes an aerial vehicle to fly to, park, and/or be serviced (e.g., charged, fueled, etc.) at an undesirable (e.g., third-party, unaffiliated, etc.) facility. For instance, an aerial facility preference can include one or more desirable facilities that are at least partially owned, operated, and/or otherwise affiliated with the aerial vehicle provider. A restricted facility flight can include a flight that lands and/or departs from an unaffiliated aerial transportation facility. A layover flight can include a flight that causes a layover under and/or over a preferred time threshold. Layover flights can include an overnight layover that violates a layover preference of a vehicle provider by exceeding a maximum time threshold. In addition, or alternatively, a layover flight can include a quick turnaround between two flights that fails to achieve a minimum time threshold. Such a flight can be determined, for example, to service a greater than expected demand at an aerial facility.

The computing system 805 can generate a flight request 830 for the at least one of the aerial vehicle provider(s) based on the determined non-conforming flight 825. For example, the flight request 830 can include a request to schedule the non-conforming flight 825. In addition, the flight request 830 can include one or more offsetting attribute(s) 835 to offset a violation of scheduling preference(s) 815 caused by the non-conforming flight 825. By way of example, the flight request 830 can include a request to schedule the non-conforming flight 825, data indicative of one or more attributes (e.g., a flight route, a destination/departure location, a passenger capacity, etc.) of the non-conforming flight 825, a preference violation associated with the non-conforming flight 825 (e.g., a passenger capacity of no passengers indicative of a deadhead flight), and/or the one or more offsetting attributes 835 to offset the preference violation. The offsetting attribute(s) 835, for instance, can include one or more guarantees (e.g., an increased payment, a capacity of a subsequent flight, etc.) to offset an expense associated with the preference violation.

For example, the computing system 805 can determine the offsetting attribute(s) 835 based, at least in part, on the multi-modal transportation services data 610 (e.g., real-time, anticipated transportation services, etc.) and the at least one scheduling preference (e.g., of the scheduling preference(s) 815) violated by the non-conforming flight 825. An offsetting attribute, for example, can include at least one of a compensation attribute, a subsequent trip attribute, and/or an infrastructure attribute. By way of example, a compensation attribute can be indicative of a compensation for facilitating the one or more aerial transportation services such as, for example, a rate guarantee (e.g., as opposed to per passenger compensation method, etc.) for performing the flight. The rate guarantee, for example, can be determined to cover one or more computing resource expenditures (e.g., fueling/charging costs, operator costs, vehicle inspection/servicing costs, etc.) of performing the non-conforming flight 825. In addition, or alternatively, the rate guarantee can include a higher rate of compensation for the non-conforming flight 825 and/or one or more flights subsequent to the non-conforming flight 825. For example, the higher rate of compensation can be determined in accordance with a demand (e.g., real-time and/or anticipated, etc.) at an aerial transportation facility. In some implementations, for example where the non-conforming flight 825 is requested in response to a deviation caused by a deviating vehicle provider, the compensation attribute can be indicative of a deviation offset provided by the deviating aerial vehicle provider.

In addition, or alternatively, the subsequent trip attribute can include a predicted and/or guaranteed capacity for a flight subsequent to the non-conforming flight 825. As an example, the offsetting attribute(s) 835 can be indicative of an anticipated capacity for a flight subsequent to the non-conforming flight 825. For instance, the non-conforming flight 825 can include a deadhead flight to service demand from a destination aerial transportation facility. In such a case, the offsetting attribute(s) 835 can include demand data indicative of an anticipated capacity for a flight subsequent to the non-conforming flight 825 (e.g., from the high demand aerial transportation facility, etc.). As another example, the non-conforming flight 825 can include a layover flight to service early demand from a destination aerial transportation facility. In such a case, the offsetting attribute(s) 835 can include demand data indicative of an anticipated capacity for an early flight subsequent to (e.g., after a layover) the non-conforming flight 825 (e.g., from the high demand aerial transportation facility, etc.). In some implementations, as discussed herein, the computing system 805 can guarantee a capacity of a subsequent and/or early flight by booking one or more passengers for the subsequent/early flight subsequent to the non-conforming flight 825 before, during, and/or after the scheduling/performance of the non-conforming flight 825.

The infrastructure attribute can include infrastructure data associated with the infrastructure of an aerial transportation facility. For example, in some implementations, an aerial transportation facility associated with a non-conforming flight 825 can include a third-party aerial facility that is unaffiliated with the at least one aerial vehicle provider (e.g., violates a restricted facility scheduling preference of the aerial vehicle provider). In such a case, the offsetting attribute(s) 835 can be indicative of the infrastructure at the third-party aerial transportation facility, an availability of the infrastructure, and/or an allowance to use the infrastructure. By way of example, the infrastructure attribute can include a guarantee to reserve and/or pay for third-party infrastructure at an unaffiliated aerial transportation facility. In some implementations, as discussed herein, the computing system 805 can guarantee the availability of the infrastructure at the unaffiliated aerial transportation facility subsequent to the non-conforming flight 825 by reserving the infrastructure before, during, and/or after the scheduling/performance of the non-conforming flight 825.

In some implementations, for example where the non-conforming flight 825 is requested in response to a deviation caused by a deviating vehicle provider, the infrastructure attribute can be indicative of a deviation offset such as, for example, a guarantee provided by the deviating aerial vehicle provider to use the infrastructure. By way of example, the offsetting attribute(s) 835 can be determined based, at least in part, on a deviation and aerial transportation facility data associated with a deviating vehicle provider. The aerial transportation facility data associated with a deviating vehicle provider can identify infrastructure and/or space at one or more transportation facilities affiliated with the deviating vehicle provider. The computing system 805 can determine, based on the aerial transportation facility data, infrastructure and/or space at one or more transportation facilities corresponding to the non-conforming flight 825. In such a case, the computing system 805 can leverage the infrastructure (e.g., computing resources, etc.) and/or space at the transportation facility(s) affiliated with the deviating vehicle provider to determine an offsetting attribute to reserve and/or guarantee the use of infrastructure and/or space at the he transportation facility(s). The computing system 805 can generate a deviation offset indicative of the offsetting attribute and provide the deviation offset to the deviating vehicle provider. The deviating vehicle provider can obtain the deviation offset and, in response, initiate one or more facility actions to reserve and/or guarantee the use of infrastructure and/or space at a respective aerial transportation facility. In this manner, the computing system 805 can pool resources associated (e.g., affiliated, etc.) with a plurality of disparate computing systems (e.g., vehicle provider computing system(s) 810 associated with each vehicle provider) to mitigate deviations caused by one vehicle provider.

In addition, or alternatively, the computing system 805 can determine the offsetting attribute(s) 835 based, at least in part, on the at least one flight type of the non-conforming flight 825. By way of example, the at least one flight type can include a deadhead flight and, in response, the computing system 805 can determine offsetting attribute(s) 835 that include an anticipated capacity for a flight subsequent to the non-conforming flight 825 to cover one or more expenses associated with the deadhead flight. As another example, the at least one flight type can include a restricted facility flight and, in response, the computing system 805 can determine offsetting attribute(s) 835 that include infrastructure attributes for a restricted facility. The infrastructure attributes, for example, can be indicative of infrastructure at the restricted facility such as, for example, one or more energy-replenishment devices at the restricted facility, an availability of the one or more energy-replenishment devices, and/or a compensation for using the one or more energy-replenishment devices. For example, the one or more energy-replenishment devices can include one of more fueling and/or charging devices at the restricted facility and the offsetting attribute(s) 835 can include a guarantee to pay, reserve, etc. the one or more fueling and/or charging devices at the restricted facility to replenish the energy of an aerial vehicle after and/or before the non-conforming flight 825.

In some implementations, the offsetting attribute(s) 835 for the non-conforming flight 825 can be determined based, at least in part, on the historical data associated with the at least one aerial vehicle provider. For example, the historical data can be indicative of one or more previous non-conforming flight requests provided to the aerial vehicle provider (e.g., vehicle provider computing system 810). The offsetting attribute(s) 835 can be determined based on an acceptance and/or rejection rate associated with one or more previous offsetting attributes corresponding to the previous non-conforming flight requests and/or any other feedback data received and/or determined from previous interactions with the aerial vehicle provider.

The computing system 805 can provide the flight request 830 to the at least one aerial vehicle provider and receive a vehicle provider response to the flight request 830. The vehicle provider response can include at least one of an acceptance and/or a denial of the flight request 830 to schedule the non-conforming flight 825. In response to a denial of the flight request 830, the computing system 805 can generate another request for one or more of the other aerial vehicle providers and/or optimize the one or more multi-modal transportation itineraries without the non-conforming flight 825. In response to an acceptance of the flight request 830, the computing system 805 can receive non-conforming flight data indicative of a scheduled flight from the aerial vehicle provider. The computing system 805 can generate one or more multi-modal transportation itineraries based on the non-conforming flight data.

The computing system 805 can perform one or more offsetting actions to provide the offsetting attribute(s) 835 to the aerial vehicle provider in response to receiving an acceptance of the flight request 830. This can include booking one or more passengers for the flight subsequent to the non-conforming flight 825 before, during, and/or after the performance of the non-conforming flight 825, providing compensation for the performance of the non-conforming flight 825, providing a deviation offset to a deviating aerial vehicle provider, reserving and/or otherwise facilitating the use of third-party infrastructure at an unaffiliated aerial transportation facility, and/or any other action to initiate the performance of offsetting attribute(s) 835.

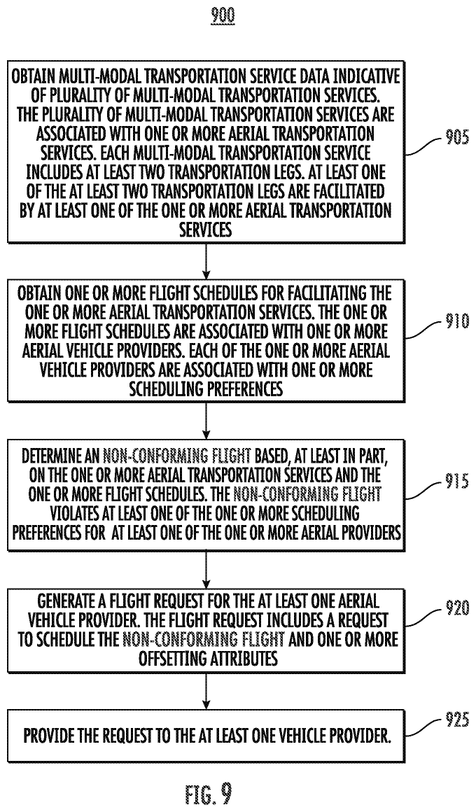

Turning to FIG. 9, FIG. 9 depicts a flow chart diagram of an example method 900 for generating a non-conforming service request according to example embodiments of the present disclosure. One or more portion(s) of the method 900 can be implemented by a computing system that includes one or more computing devices such as, for example, the computing systems described with reference to the other figures (e.g., service entity computing system 102, vehicle provider computing system(s) 140, computing system 805, etc.). Each respective portion of the method 900 can be performed by any (or any combination) of one or more computing devices. Moreover, one or more portion(s) of the method 900 can be implemented as an algorithm on the hardware components of the device(s) described herein (e.g., as in FIGS. 1, 4, 8, 10, etc.), for example, to generate a request. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for exemplary illustrated purposes and is not meant to be limiting. One or more portions of method 900 can be performed additionally, or alternatively, by other systems.

FIG. 9 depicts one example scenario in which a vehicle provider is associated with an aerial modality for exemplary purposes only. It should be noted that the vehicle provider can include different vehicle providers associated with any transportation modality such as, for example, any of the transportation modalities described herein.

At 905, the method 900 can include obtaining multi-modal transportation service data indicative of a plurality of multi-modal transportation services. For example, a computing system (e.g., service entity computing system 102, optimization/planning system 130, computing system 805, etc.) can obtain the multi-modal transportation service data indicative of the plurality of multi-modal transportation services. The plurality of multi-modal transportation services can be associated with one or more aerial transportation services. Each multi-modal transportation service can include at least two transportation legs. At least one of the at least two transportation legs can be facilitated by at least one of the one or more aerial transportation services.

At 910, the method 900 can include obtaining one or more flight schedules for facilitating the one or more aerial transportation services. For example, the computing system (e.g., service entity computing system 102, optimization/planning system 130, computing system 805, etc.) can obtain the one or more flight schedules for facilitating the one or more aerial transportation services. The one or more flight schedules can be associated with one or more aerial vehicle providers. Each of the one or more aerial vehicle providers can be associated with one or more scheduling preferences.

At 915, the method 900 can include determining a non-conforming flight based, at least in part, on the one or more aerial transportation services and the one or more flight schedules. For example, the computing system (e.g., service entity computing system 102, optimization/planning system 130, computing system 805, etc.) can determine the non-conforming flight based, at least in part, on the one or more aerial transportation services and the one or more flight schedules. The non-conforming flight can violate at least one of the one or more scheduling preferences for at least one of the one or more aerial vehicle providers.

At 920, the method 900 can include generating a flight request for the at least one aerial vehicle provider. For example, the computing system (e.g., service entity computing system 102, optimization/planning system 130, computing system 805, etc.) can generate the flight request for the at least one aerial vehicle provider. The flight request can include a request to schedule the non-conforming flight and one or more offsetting attributes.

At 925, the method 900 can include providing the request to the at least one vehicle provider. For example, the computing system (e.g., service entity computing system 102, optimization/planning system 130, computing system 805, etc.) can provide the request to the at least one vehicle provider.

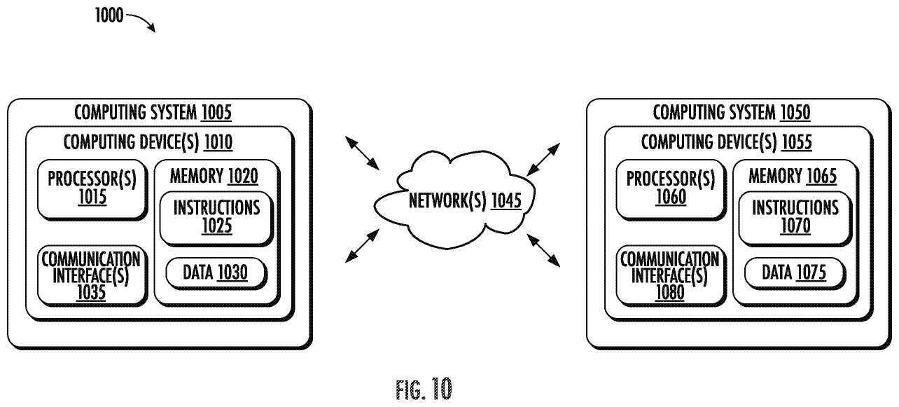

FIG. 10 depicts example system components of an example system 1000 according to example embodiments of the present disclosure. The example system 1000 can include the computing system 1005 (e.g., service entity computing system 102, computing system 805, etc.) and the computing system(s) 1050 (e.g., vehicle provider computing system(s) 140, rider computing device(s) 145, service provider computing device(s) 150, 160, 170, infrastructure and operations computing device(s) 190, etc.), etc. that are communicatively coupled over one or more network(s) 1045.

The computing system 1005 can include one or more computing device(s) 1010. The computing device(s) 1010 of the computing system 1005 can include processor(s) 1015 and a memory 1020. The one or more processors 1015 can be any suitable processing device (e.g., a processor core, a microprocessor, an ASIC, a FPGA, a controller, a microcontroller, etc.) and can be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 can store information that can be accessed by the one or more processors 1015. For instance, the memory 1020 (e.g., one or more non-transitory computer-readable storage mediums, memory devices) can include computer-readable instructions 1025 that can be executed by the one or more processors 1015. The instructions 1025 can be software written in any suitable programming language or can be implemented in hardware. Additionally, or alternatively, the instructions 1025 can be executed in logically and/or virtually separate threads on processor(s) 1015.

For example, the memory 1020 can store instructions 1025 that when executed by the one or more processors 1015 cause the one or more processors 1015 to perform operations such as any of the operations and functions for which the computing system is configured, as described herein.

The memory 1020 can store data 1030 that can be obtained, received, accessed, written, manipulated, created, and/or stored. The data 1030 can include, for instance, multi-modal transportation services data, vehicle data, flight data, and/or other data/information described herein. In some implementations, the computing device(s) 1010 can obtain from and/or store data in one or more memory device(s) that are remote from the computing system 1005 such as one or more memory devices of the computing system 1050.

The computing device(s) 1010 can also include a communication interface 1035 used to communicate with one or more other system(s) (e.g., computing system 1050). The communication interface 1035 can include any circuits, components, software, etc. for communicating via one or more networks (e.g., 1045). In some implementations, the communication interface 1035 can include for example, one or more of a communications controller, receiver, transceiver, transmitter, port, conductors, software and/or hardware for communicating data/information.

The computing system 1050 can include one or more computing devices 1055. The one or more computing devices 1055 can include one or more processors 1060 and a memory 1065. The one or more processors 1060 can be any suitable processing device (e.g., a processor core, a microprocessor, an ASIC, a FPGA, a controller, a microcontroller, etc.) and can be one processor or a plurality of processors that are operatively connected. The memory 1065 can include one or more non-transitory computer-readable storage media, such as RAM, ROM, EEPROM, EPROM, one or more memory devices, flash memory devices, etc., and combinations thereof.

The memory 1065 can store information that can be accessed by the one or more processors 1060. For instance, the memory 1065 (e.g., one or more non-transitory computer-readable storage mediums, memory devices) can store data 1075 that can be obtained, received, accessed, written, manipulated, created, and/or stored. The data 1075 can include, for instance, vehicle data, privilege data, preferences data, and/or other data or information described herein. In some implementations, the computing system 1050 can obtain data from one or more memory device(s) that are remote from the computing system 1050.

The memory 1065 can also store computer-readable instructions 1070 that can be executed by the one or more processors 1060. The instructions 1070 can be software written in any suitable programming language or can be implemented in hardware. Additionally, or alternatively, the instructions 1070 can be executed in logically and/or virtually separate threads on processor(s) 1060. For example, the memory 1065 can store instructions 1070 that when executed by the one or more processors 1060 cause the one or more processors 1060 to perform any of the operations and/or functions described herein, including, for example, any of the operations and functions of the devices described herein, and/or other operations and functions.

The computing device(s) 1055 can also include a communication interface 1080 used to communicate with one or more other system(s). The communication interface 1080 can include any circuits, components, software, etc. for communicating via one or more networks (e.g., 1045). In some implementations, the communication interface 1080 can include for example, one or more of a communications controller, receiver, transceiver, transmitter, port, conductors, software and/or hardware for communicating data/information.

The network(s) 1045 can be any type of network or combination of networks that allows for communication between devices. In some embodiments, the network(s) 1045 can include one or more of a local area network, wide area network, the Internet, secure network, cellular network, mesh network, peer-to-peer communication link and/or some combination thereof and can include any number of wired or wireless links. Communication over the network(s) 1045 can be accomplished, for instance, via a network interface using any type of protocol, protection scheme, encoding, format, packaging, etc.

FIG. 10 illustrates one example system 1000 that can be used to implement the present disclosure. Other computing systems can be used as well. Computing tasks discussed herein as being performed at a transportation services system, the simulation computing system, etc. can instead be performed remote from the respective system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system comprising:
one or more processors; and
one or more tangible, non-transitory, computer readable media that collectively store instructions that when executed by the one or more processors cause the computing system to perform operations, the operations comprising:
obtaining multi-modal transportation service data indicative of a plurality of multi-modal transportation services, wherein each multi-modal transportation service comprises at least two transportation legs, wherein at least one of the at least two transportation legs are facilitated by at least one of the one or more transportation services;
obtaining one or more transportation schedules for facilitating the one or more transportation services, the one or more schedules associated with one or more vehicle providers, wherein each of the one or more vehicle providers are associated with one or more scheduling preferences;
determining a non-conforming service based, at least in part, on the one or more transportation services and the one or more transportation schedules, wherein the non-conforming service violates at least one of the one or more scheduling preferences for at least one of the one or more vehicle providers;
determining one or more offsetting attributes associated with the non-conforming service based, at least in part, on the multi-modal transportation service data;
generating a request for the at least one vehicle provider, the request comprising a request to schedule the non-conforming service and the one or more offsetting attributes; and
providing the request to the at least one vehicle provider.

2. The computing system of claim 1, wherein the multi-modal transportation service data comprises prediction data indicative of a plurality of anticipated transportation services at one or more future times.

3. The computing system of claim 2, wherein determining the non-conforming service based, at least in part, on the one or more transportation services and the one or more schedules comprises:
identifying one or more anticipated transportation services of the plurality of anticipated transportation services that are not achieved by the one or more schedules; and
determining the non-conforming service to facilitate the one or more anticipated transportation services.

4. The computing system of claim 3, wherein determining the one or more offsetting attributes comprises:
determining the one or more offsetting attributes based, at least in part, on the one or more anticipated transportation services and the at least one scheduling preference violated by the non-conforming service.

5. The computing system of claim 1, wherein the one or more scheduling preferences comprise at least one of a deadhead avoidance preference, a route preference, a facility preference, or a layover preference.

6. The computing system of claim 5, wherein the non-conforming service is associated with at least one of one or more service types, the one or more service types comprising a deadhead service that violates the deadhead avoidance preference, a restricted route service that violates the route preference, a restricted facility service that violates the facility preference, or a layover service that violates the layover preference.

7. The computing system of claim 6, wherein the operations further comprise:
determining the one or more offsetting attributes based, at least in part, on the at least one service type.

8. The computing system of claim 7, wherein the at least one service type is the deadhead service, and wherein the one or more offsetting attributes are indicative of an anticipated capacity for a service subsequent to the non-conforming service.

9. The computing system of claim 8, wherein the operations further comprise:
booking one or more passengers for the service subsequent to the non-conforming service before or during a performance of the non-conforming service.

10. The computing system of claim 7, wherein the at least one type is the restricted facility type, and wherein the one or more offsetting attributes comprise infrastructure attributes for a restricted facility, the infrastructure attributes indicative of infrastructure at the restricted facility.

11. The computing system of claim 10, wherein the infrastructure attributes are indicative of one or more energy-replenishment devices at the restricted facility, an availability of the one or more energy-replenishment devices, or a compensation for using the one or more energy-replenishment devices.

12. The computing system of claim 1, wherein each of the one or more vehicle providers are associated with historical data, and wherein the one or more offsetting attributes for the non-conforming service are determined based, at least in part, on the historical data associated with the at least one vehicle provider.

13. A computer-implemented method, the method comprising:
obtaining, by a computing system comprising one or more computing devices, multi-modal transportation service data indicative of a real-time demand for one or more multi-modal transportation services, wherein each multi-modal transportation service comprises at least two transportation legs, wherein at least one of the at least two transportation legs are facilitated by at least one of the one or more transportation services;
obtaining, by the computing system, one or more schedules for facilitating the one or more transportation services, the one or more schedules associated with one or more vehicle providers, wherein each of the one or more vehicle providers are associated with one or more scheduling preferences;
determining, by the computing system, a non-conforming service for facilitating the one or more transportation services, wherein the non-conforming service violates at least one of the one or more scheduling preferences for at least one of the one or more vehicle providers;
generating, by the computing system, a request for the at least one vehicle provider, the request comprising a request to schedule the non-conforming service and one or more offsetting attributes; and
providing, by the computing system, the request to the at least one vehicle provider.

14. The computer-implemented method of claim 13, wherein the real-time demand for the one or more transportation services correspond to a transportation facility.

15. The computer-implemented method of claim 14, wherein the non-conforming service comprises a route to the transportation facility.

16. The computer-implemented method of claim 15, wherein the one or more offsetting attributes are indicative of an additional compensation for facilitating the one or more transportation services.

17. The computer-implemented method of claim 14, wherein the transportation facility is a third-party facility that is unaffiliated with the at least one vehicle provider.

18. The computer-implemented method of claim 17, wherein the one or more offsetting attributes are indicative of infrastructure at the third-party transportation facility, an availability of the infrastructure, or an allowance to use the infrastructure.

19. A computing system comprising:
one or more processors; and
one or more tangible, non-transitory, computer readable media that collectively store instructions that when executed by the one or more processors cause the computing system to perform operations, the operations comprising:
obtaining multi-modal transportation service data indicative of a plurality of multi-modal transportation services, wherein the plurality of multi-modal transportation services are associated with one or more transportation services, wherein each multi-modal transportation service comprises at least two transportation legs, wherein at least one of the at least two transportation legs are facilitated by at least one of the one or more transportation services;
obtaining data from one or more vehicle providers, the data indicative of a number of vehicles at one or more times for facilitating the one or more transportation services, wherein the data is associated with one or more permissions corresponding to at least one of the one or more vehicle providers;
generating one or more multi-modal transportation itineraries based, at least in part, on the multi-modal transportation service data and the data indicative of the number of vehicles at the one or more times for facilitating the one or more transportation services;
determining a deviation associated with the data indicative of the number of vehicles at the one or more times for facilitating the one or more transportation services from the at least one vehicle provider, the deviation indicative of a lower number of vehicles at one or more of the one or more times;
generating one or more modified multi-modal transportation itineraries based, at least in part, on the deviation and the one or more multi-modal transportation itineraries;
generating a deviation offset based, at least in part, on the one or more modified itineraries and the one or more permissions; and
providing the deviation offset to the at least one vehicle provider.

20. The computing system of claim 19, wherein the one or more permissions comprise a compensation for the deviation, and wherein the deviation offset comprises an inefficiency associated with the one or more modified multi-modal transportation itineraries.
